(19) United States
(12) Patent Application Publication
(10) Pub. No.: US 2015/0200998 A1
(43) Pub. Date: Jul. 16, 2015

(54) DISPLAYING PORTIONS OF A HOST DISPLAY AREA OF A HOST DEVICE AT A CLIENT DEVICE

(71) Applicants: Qunshan Gu, Hayward, CA (US); Wei Jia, San Jose, CA (US)

(72) Inventors: Qunshan Gu, Hayward, CA (US); Wei Jia, San Jose, CA (US)

(73) Assignee: GOOGLE INC., Mountain View, CA (US)

(21) Appl. No.: 13/361,643

(22) Filed: Jan. 30, 2012

(51) Int. Cl. H04L 29/08

(52) U.S. Cl. CPC H04L 67/025

(57) ABSTRACT

In one general aspect, a process can include sending from a client device to a host device an indicator of a size of a target display area of the client device and an offset boundary defining a boundary limiting movement of the target display area with respect to a host display area of an application operating at the host device where the application is remotely controlled via the client device. The process can include defining an indicator of a position of the target display area of the client device with respect to the host display area, and can include receiving from the host device an image of a target display area of the host display area of the application where the host display area has a resolution different from a resolution of the target display area of the client device.

### RELATED APPLICATIONS

This application is related to U.S. Non-provisional patent application, filed on the same date as this application, entitled “Caching for Smooth Transitions within a Client-Host Session”, attorney docket no. 0058-309001, and related to U.S. Non-provisional patent application, filed on the same date as this application, entitled “Encoding Scheme for Displaying Host Content”, attorney docket no. 0058-311001, both of which are incorporated by reference herein in their entireties.

### TECHNICAL FIELD

This description relates to caching smooth transitions within a client-host session.

### BACKGROUND

A client device can be used to interact with an application operating at a host device via a client-host session (e.g., a client-host session). The host device can be configured to define a stream of images (e.g., stream of screenshots) representing the interactions of the client device with the application, and can send the stream of images to the client device as the interactions are occurring via the client-host session. In some known client-host systems, the image processing capabilities of the client device can be different from the image processing capabilities of the host device. In some known client-host systems, the host device can be configured to encode (e.g., compress) the images before sending the images to the client device where they are displayed; the compressed images can consume significant bandwidth over a connection between the client device and the host device. If image updates consume too much bandwidth of the connection, interactions between the client device and the host device during a client-host session can be, for example, disrupted. Also, consumption of bandwidth for updates of the images at the client device can reduce the available bandwidth, which can already be limited, for other functions. Thus, a need exists for systems, methods, and apparatus to address the shortfalls of present technology and to provide other new and innovative features.

### SUMMARY

In one general aspect, a computer-readable storage medium can be configured to store instructions that when executed cause a processor to perform a process. The process can include sending from a client device to a host device an indicator of a size of a target display area of the client device and an offset boundary defining a boundary limiting movement of the target display area with respect to a host display area of an application operating at the host device where the application is remotely controlled via the client device. The processing can include defining an indicator of a position of the target display area of the client device with respect to the host display area, and can include receiving from the host device an image of a target display area of the host display area of the application where the host display area has a resolution different from a resolution of the target display area of the client device.

In another general aspect a method can include establishing at least a portion of a remote desktop session between a client device and a host device, and receiving an offset boundary defining a boundary for movement of a target display area with respect to a host display area of an application operating at the host device. The method can include receiving from the client device an indicator of a position of a target display area within a host display area of an application operating at the host device. The method can also include defining a client image based on a portion of a host image corresponding with the target display area at the position within the host display area where the image of the target display area having an area smaller than an area of the host image of the host display area, and sending the client image to the client device.

In yet another general aspect, an apparatus can include a host connection module of a host device configured to exchange a plurality of an initialization parameter values with a client device during establishment of a remote desktop session between the host device and the client device. At least a portion of the plurality of initialization parameter values can identify an aspect ratio of a target display area with respect to a plurality of host images produced within a host display area by an application operating at the host device. The apparatus can include a host target movement module configured to receive from the client device an indicator of a position of the target display area with respect to the host display area, and a client image generator configured to define a client image based on at least one host image from the plurality of host images produced within the host display area and based on the indicator of the position of the target display area with respect to the host display area.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates a client device and a host device configured to communicate via a client-host session.

FIG. 2 is a diagram that illustrates a client device including a client display module and the host device including a host display module.

FIGS. 3A through 3F illustrate client images produced based on host images.

FIG. 4 is a diagram that illustrates an example of an offset boundary within a host display area and related to a target display area.

FIG. 5 is a diagram that illustrates an example of another offset boundary associated with a host display area and related to a target display area.

FIG. 6A through 6E illustrate a target display area and a host display area that have different aspect ratios.

FIG. 7 is a timing diagram that illustrates communication between a client device and a host device during a client-host session associated with a moving window.

FIG. 8 is a flowchart that illustrates a method for processing images at a client device remotely controlling an application operating at a host device, according to an embodiment.

FIG. 9 is a flowchart that illustrates a method for processing images related to a client-host session, according to an embodiment.

FIGS. 10A through 10D are diagrams that illustrate transition images produced based on copied host images, according to an embodiment.

FIG. 11 is a flowchart that illustrates a method related to processing transition images, according to an embodiment.

FIG. 12 is a flowchart that illustrates another method related to processing transition images, according to an embodiment.

FIG. 13 is a diagram that illustrates the client device and the host device shown in FIG. 2 modified to process mirrored host images.

FIG. 14 is a timing diagram that illustrates processing based on mirrored host images, according to an embodiment.

FIG. 15 is a flowchart that illustrates a method for processing mirrored images, according to embodiment.

FIG. 16 is a timing diagram that illustrates triggering of display of client images based on a mirrored host image, according to an embodiment.

FIG. 17 is a timing diagram that illustrates processing of client images based on mirrored host images in response to changes in a location of a target display area, according to an embodiment.

FIG. 18 is a timing diagram that illustrates a modification to the timing diagram shown in FIG. 17.

FIG. 19 is a timing diagram that illustrates updating of a mirrored host image based on a sequence of client images in response to changes in a location of a target display area, according to an embodiment.

FIG. 20 is a flowchart that illustrates a method for processing mirrored images associated with a sequence of client images, according to embodiment.

### DETAILED DESCRIPTION

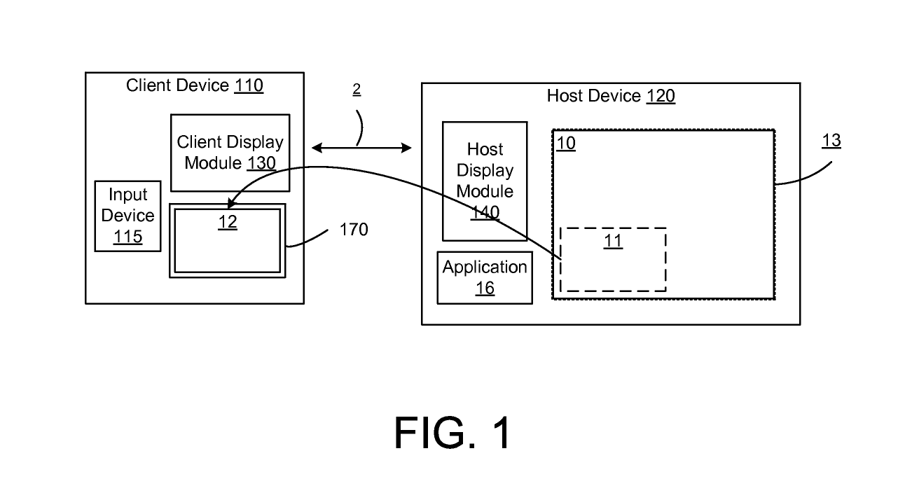

FIG. 1 is a diagram that illustrates a client device 110 and a host device 120 configured to communicate via a client-host session. The client device 110, in this embodiment, is configured to operate as a client (e.g., a thin client) of the host device 120 via, for example, a client-host session (e.g., a remote desktop session). The client device 110 can be used to interact with an application 16 and/or other applications (not shown) operating at the host device 120 via a communication link 2, and the host device 120 can be configured to send to the client device 110 a stream of images (e.g., screen scrapes, screenshots) (also can be referred to as a stream of frames) representing responses to interactions with the application 16 during a client-host session. Accordingly, the processing resources of the host device 120, which may be faster, more efficient, more abundant, etc. than the resources of the client device 110, can be used by the client device 110 to operate the application 16 via the communication link 2 during the client-host session. For example, the stream of images can be screenshots that are updated as the client device 110 is used to interact with the application 16 operating at the host device 120. Interactions with the application 16 can be triggered using an input device 115 (e.g., an indicator (or input value) from the input device 115, a mouse device, a touchscreen device, a keyboard device, a touchpad device, a microphone) of the client device 110 via the stream of images. In some embodiments, the interactions with the application 16 can be represented by one or more input values produced by the input device 115. Although only application 16 is shown in this embodiment, multiple applications can be operating at the host device 120 and can be controlled via the client device 110 in some embodiments.

As a specific example, a user interface associated with the application 16 can be generated at the host device 120 operating the application 16. The client device 110 (e.g., the input device 115 of the client device 110) can be used by a user to interact with the user interface of the application 16 and input values representing the interactions can be sent to the host device 120 via the communication link 2 during a client-host session. Images of the user interface, and interactions with the user interface (which can result in changes to the user interface), can be streamed, via the communication link 2, to the client device 110 where they can be displayed at the client device 110. In some embodiments, the stream of images can, for example, define, or can be used to define, images in a video stream.

In this embodiment, a client image 12 of (e.g., derived from) a host image 10 associated with the application 16 operating at the host device 120 is sent via the communication link 2 to the client device 110 based on a position (e.g., an x-y position) of a target display area 11 of the host image 10. The client image 12 is displayed (e.g., rendered) in a display 170 of the client device 110. In some embodiments, the client image 12 can be referred to as a window image, as an image of the target display area 11, or as a captured image of the target display area 11. The target display area 11 outlines a portion (e.g., a relatively small portion, a subset) of the host image 10 as illustrated by the dashed line. The host image 10 can be an image of, for example, a user interface of the application 16 operating at the host device 120. The host image 10 can be one image from a stream of images (e.g., a stream including consecutive images) produced by the application 16 (or using the application 16) at the host device 120 during operation of the application 16. In some embodiments, the target display area 11 can be referred to as a target display window or as a target viewing window. In some embodiments, the client image 12 can be referred to as a screen cast portion, a capture portion, a fragment of the host image 10, and/or so forth.

As shown in FIG. 1, processing related to the target display area 11 and processing related to the host image 10 are handled by a host display module 140 operating at host device 120. The host display module 140 is configured produce the client image 12 that is sent to the client device 110. The client display module 130 receives the client image 12 of the target display area 11. The client display module 130 handles processing related to the client image 12 of the target display area 11 at the client device 110.

Because the display 170 of the client device 110 has an area with a different size than an area of the host image 10 associated with the application 16 at the host device 120, only the target display area 11 of the host image 10 is sent to the client device 110 as the client image 12 for display in the display 170. In some embodiments, the host image 10 can be referred to as a full scope image because it is a full resolution image that is produced by the application 16 (and/or other applications operating at host device 120 such as an operating system). The host image 10 can be an image (e.g., a bitmap image, a compressed image, an encoded image) of at least a portion of a host display area 13 (e.g., a full display area, an entire visual user interface operating environment, etc.) associated with the application 16 (and/or other applications operating at the host device 120 such as an operating system). In some embodiments, the host image 10 can be referred to as a native host image or as a native image of the host display area 13. The target display area 11 of the host image 10 can be referred to as a target display area because the target display area 11 is a portion of the host image 10 that is targeted to be captured and sent to the client device 110 for viewing as client image 12 on the display 170 of the client device 110.

Because the display 170 of the client device 110 has an area that is smaller than an area of the host image 10 (e.g., the host image 10 within the host display area 13) processed at the host device 120, only the client image 12 of the target display area 11 (which includes only a portion of the host image 10) is sent to the client device 110 for display. In this embodiment, the client image 12 of the target display area 11 has a resolution that is the same as a resolution of the target display area 11 of the host image 10. In other words, the client image 12 of the target display area 11 is not scaled up or down compared with the target display area 11 of the host image 10. In some embodiments, the client image 12 of the target display area 11 can be scaled up or down from the target display area 11 of the host image 10.

The target display area 11 can be moved within the host display area 13 so that the user of the client device 110 can view other portions (e.g., any portion) of the host image 10, or other host images (not shown). In some embodiments, the target display area 11 can be moved from a first position within the host display area 13 of the host image 10 to a second position within the host display area 13 of the host image 10. In some embodiments, the host display area 13 can have a size that is the same as, or substantially the same as, the host image 10. In some embodiments, the host image 10 can have a size that is different (e.g., smaller, larger) than the host display area 13.

As shown in FIG. 1, the target display area 11 is in a lower-left quadrant of the host display area 13 corresponding with the host image 10. Although not shown in FIG. 1, the client device 110 can be configured so that the target display area 11 can be moved (e.g., triggered to be moved by a user of the client device 110) from the lower-left quadrant of the host image 10 to a new position within the host display area 13. The target display area 11 can be triggered to move within the host display area 13 in response to one or more input values from the input device 115 of the client device 110. In response to the movement of the target display area 11 to the new position within the host display area 13, an image (not shown) of the target display area 11 in the new position of the host image 10, or another image, within the host display area 13 can be sent to the client device 110.

Accordingly, the client device 110 can function as a viewing window, via the target display area 11, into the application 16 (and/or other applications) operating at the host device 120. In other words, the client device 110 can function as an extension of the host device 120 that can be used to view and/or control one or more portions of the application 16 operating in host device 120. In some embodiments, a client-host session through which the client device 110 can function as a viewing window, via the target display area 11, into the application 16 operating at host device 120 can be referred to as a viewing window session or as a moving window session.

As a specific example, a word processing application (i.e., application 16) can be operating at the host device 120 and controlled at the host device 120 using the client device 110 during a client-host session. The user interface associated with the word processing application can be processed at host device 120 as host images (e.g., host image 10). Portions of the user interface associated with the word processing application can be displayed (e.g., viewed) at the display 170 of the client device 110 as images (e.g., client image 12) based on a location of a target display area (e.g., target display area 11). A user of the client device 110 may interact with the word processing application using the input device 115 via the portions of the user interface that are displayed at the client device 110 and/or may move the target display area using the input device 115. In response to the interaction(s), the user interface associated with the word processing application can be updated, and updated images can be sent to and displayed at the client device 110.

Although not shown in FIG. 1, in some embodiments, the host image 10 may be displayed at the host device 120 on a display of host device 120. In some embodiments, the host image 10 may not be displayed at the host device 120, but may instead be processed at the host device 120 by one or more processors (not shown) and/or may be stored (e.g., temporarily store) in the memory (not shown) of the host device 120.

In some embodiments, the communication link 2 can be, for example, a wireless communication link, a wired communication link, a network communication link, and/or so forth. As used herein, the term “client-host session” can include any technologies and/or protocols in which commands (e.g., input values) issued from a local client are used to control the functionality (e.g., operation) of a host device (e.g., host device 120) including, for example, Windows Remote Desktop™, Citrix™, WebEx™ etc. technologies and/or protocols.

In some implementations, the client device 110 and/or the host device 120 can each be, for example, a wired device and/or a wireless device (e.g., wi-fi enabled device) and can be, for example, a computing entity (e.g., a personal computing device), a server device (e.g., a web server), a mobile phone, a touchscreen device, a personal digital assistant (PDA), a laptop, a television including, or associated with, one or more processors, a tablet device, e-reader, and/or so forth. The computing device(s) can be configured to operate based on one or more platforms (e.g., one or more similar or different platforms) that can include one or more types of hardware, software, firmware, operating systems, runtime libraries, and/or so forth.

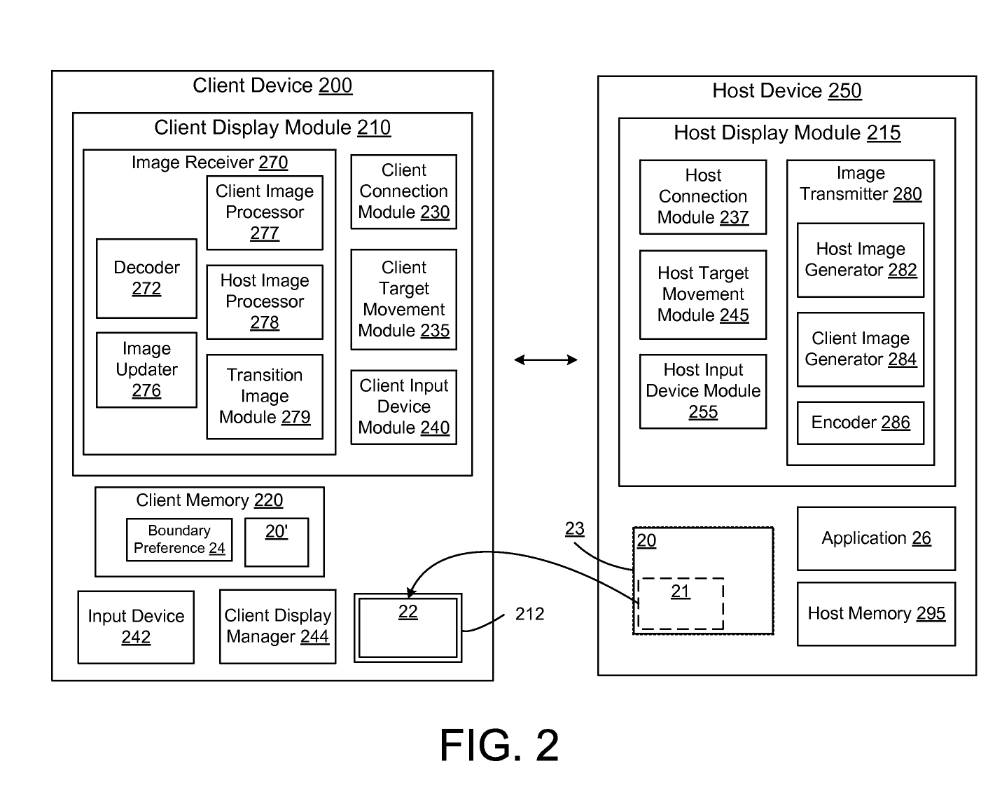

FIG. 2 is a diagram that illustrates a client device 200 including a client display module 210 and a host device 250 including a host display module 215. The host device 250 and the client device 200 can be configured to communicate via a client-host session (e.g., a remote desktop session). The client device 200 can be used to interact with an application 26 operating at the host device 250, and the host device 250 can be configured to send to the client device 200 a client image 22 (which can be from a stream of client images) that is a portion of a host image 20 (which can be from a stream of host images produced using the application 26). The client image 22, which can be displayed at a display 212 of the client device 200, can be produced based on a target display area 21 within a host display area 23 (illustrated by dashed line) of the host image 20. In some embodiments, the host image 20 can be produced based on, for example, interactions with the application 26 during the client-host session. The client image 22 can be updated (e.g., replaced with different client images) within the display 212 of the client device 110 as interactions with the application 26 operating at the host device 250 occur. Interactions with the application 26 can be triggered using an input device 242 (e.g., a mouse device, a keyboard device, a touchscreen device, a touchpad device) of the client device 200 via the client image 22 (and/or updates thereof).

The host image 20 can be produced by a host image generator 282 of an image transmitter 280. Specifically, the host image 20 (and other host images which can be included in a stream of host images (not shown)) can be produced (e.g., produced as a bitmap) in response processing performed by the application 26. Also shown in FIG. 2, the image transmitter 280 includes a client image generator 284. The client image generator 284 is configured to produce the client image 22 (and other client images which can be included in a stream of client images (not shown)) from the host image 20 based on a position (e.g., an x-y position) of the target display area 21 within the host display area 23 of the host image 20. Specifically, the client image generator 284 is configured to produce the client image 22 as an image that corresponds with the target display area 21 within the host display area 23 of the host image 20.

As shown in FIG. 2, the client display module 210 includes an image receiver 270. The image receiver 270 includes a client image processor 277 configured to process (e.g., parse, store) images produced by the client image generator 284. Also, the image receiver 270 includes a host image processor 278 configured to process (e.g., parse, store) images produced by the host image generator 282.

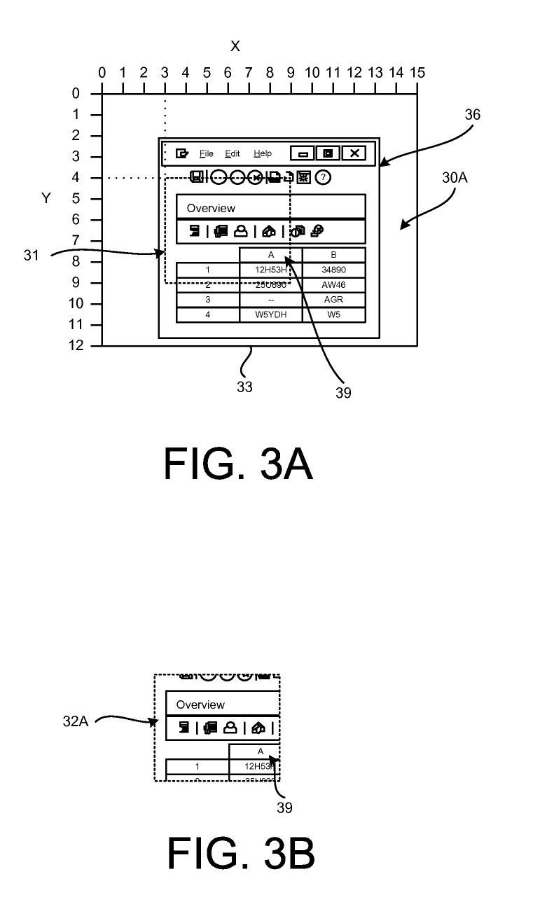

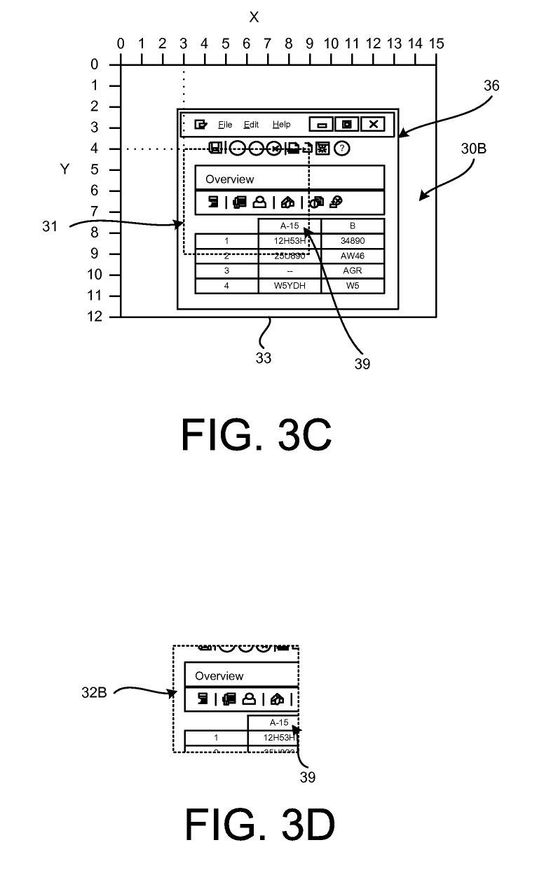

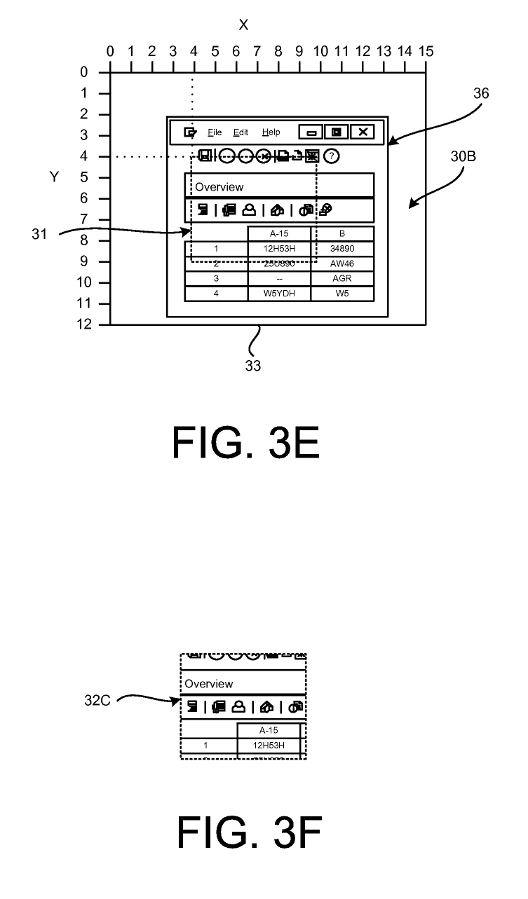

An example of client images produced based on host images are illustrated in FIGS. 3A through 3F. Specifically, FIGS. 3A, 3C, and 3E illustrate host images, and FIGS. 3B, 3D, and 3F illustrate client images produced, respectively, based on a target display area 31 within a host display area 33 of the host images.

FIG. 3A is a diagram that illustrates the target display area 31 within the host display area 33 of a host image 30A. As shown in FIG. 3A, the target display area 31 is at an x-y position (e.g., x-y coordinates) of (3,4) with respect to an origin of (0,0) at an upper-left corner of the host display area 33. In some embodiments, the x-y position of coordinates used to define a position of the target display area 31 within the host display area 33 can be referred to as an offset, as a target offset, or as target coordinates. As shown in FIG. 3A, the host image 30A includes at least a portion of a user interface 36 associated with an application. In some embodiments, the host image 30A can be produced by a host image generator such as host image generator 282 shown in FIG. 2.

Although the origin of the host display area 33 shown in FIG. 3A is at the upper-left corner of the host display area 33, in some embodiments, the origin can be in a different location. For example, an origin of a host display area can be in the bottom-right corner of the host display area, in a middle portion of the host display area, and/or so forth. Also, as shown in FIG. 3A, the target display area 31 has a position based on an upper-left corner of the target display area 31. Although not shown in FIG. 3A, in some embodiments, the target display area 31 can have a position based on a different portion of the target display area 31. For example, the target display area 31 can have a position based on a bottom-right corner of the target display area 31, a middle portion of the target display area 31, and/or so forth.

FIG. 3B illustrates a client image 32A produced based on the position of the target display area 31. The client image 32A corresponds with the target display area 31 within the host image 30A. As shown in FIG. 3A, the target display area 31 has a width of approximately 6 units (e.g., grid increments, coordinate increments) (between 3 and 9 on the x axis), and a height of approximately 5 units (between 4 and 9 on the y axis). Accordingly, the client image 32A shown in FIG. 3B also has a width of approximately 6 units and a height of approximately 5 units. In some embodiments, the client image 32A can be produced by a client image generator such as client image generator 284 shown in FIG. 2.

Referring back to FIG. 2, the image transmitter 280 includes an encoder 286. The encoder 286 is configured to encode (e.g., compress, encode using an encoding algorithm) one or more images before the images are sent from host device 250 to the client device 200. In some embodiments, the encoder 286 can be configured to encode one or more images based on a proprietary encoding algorithm, a lossy encoding algorithm, a lossless encoding algorithm, a motion picture editors group (MPEG) compression algorithm (e.g., MPEG-2, MPEG-4), and/or so forth.

In some embodiments, the encoder 286 is configured to encode the portion of the host image 20 that is transmitted to the client device 200 as client image 22. In other words, in some embodiments, the client image 22 can be encoded by the encoder 286 of the image transmitter 280 at the host device 250 before the client image 22 is sent to the client device 200.

As shown in FIG. 2, the image receiver 270 includes a decoder 272. The decoder 272 is configured to decode images that have been encoded at the host device 250 and are received at the client device 200. In some embodiments, the decoder 272 can be a decoder that corresponds with the encoder 286 of host device 250. Accordingly, the decoder 272 can be configured to decode any image that is encoded by the encoder 286. For example, if the client image 22 is encoded at the host device 250 before being received at the client device 200, the decoder 272 can be used to decode the client image 22 so that the client image 22 can be displayed at the display 212.

As shown in FIG. 2, the client display module 210 includes a client input device module 240 configured to produce one or more input values based on interactions with the client image 22 using the input device 242. The input values produced by the client input device module 240 can be sent (via the client-host session) to the host device 250. Specifically, the input values produced by the client input device module 240 can be received by the host input device module 255.

For example, the client input device module 240 can be configured to produce an input value representing movement of a position of a cursor related to, clicking of, etc. of a mouse device (which can be a type of input device 242). The client input device module 240 can be configured to produce an input value representing a selection of a portion of the client image 22 (e.g., selection of a hyperlink, selection of a portion of a user interface represented within the client image 22) using the input device 242. In some embodiments, the client input device module 240 can be configured to produce an input value related to data input into (e.g., inserted into, populated within) one or more fields represented within the client image 22, for example, by a keyboard device (which can be a type of input device 242).

In some embodiments, a position (e.g., coordinates) of a cursor, a selection, and/or so forth within the client image 22 can be used by the client input device module 240 and/or the host input device module 255 to calculate (e.g., determine, identify) a position (e.g., coordinates) with respect to the host display area 23. For example, a position (e.g., an offset with respect to an origin) of a cursor within the client image 22 can be used in conjunction with a position (e.g., an offset with respect to an origin) of the client image 22 within the host display area 23 to calculate (e.g., derive) a position of the cursor within the host display area 23. In some embodiments, the client input device module 240 can be configured to use the position information (e.g., the position of the cursor within the client image 22 and the position of the client image 22 within the host display area 23) to calculate the position of the cursor within the host display area 23. Alternatively, the host input device module 255 can be configured to calculate the position of the cursor within the host display area 23 based on the position information (e.g., the position of the cursor within the client image 22 and the position of the client image 22 within the host display area 23). In some embodiments, information about position of the cursor within the client image 22 can be sent to the host input device module 255 so that the host input device module 255 can calculate the position of the cursor within the host display area 23.

In some embodiments, the display 212 can function as an input device (e.g., input device 242). In such embodiments, the display 212 can be, for example, a touch sensitive display that can be, or can include, for example, an electrostatic touch device, a resistive touchscreen device, a surface acoustic wave (SAW) device, a capacitive touchscreen device, a pressure sensitive device, a surface capacitive device, a projected capacitive touch (PCT) device, and/or so forth. If the display 212 is, for example, a touch sensitive device, one or more input values can be produced by the client input device module 240 based on physical interactions of a user with the display 212. For example, the display 212 can be configured to display a virtual keyboard (e.g., emulate a keyboard) that can be used by a user as an input device.

In some embodiments, the client image 22 displayed within the display 212 can be modified (e.g., replaced, updated) in response to an input value. For example, a user interface element associated with a function of the application 26 represented within the client image 22 can be selected using the input device 242. The client input device module 240 can define an input value representing selection of the user interface element associated with the function. The input value can be received by the host input device module 255, and can be used to trigger a function of the application 26 (and/or another application operating at the host device 250). Execution of the function of the application 26 can result in a modification (e.g., an update) to the host image 20 performed by the host image generator 282. The modification to the host image 20 can be reflected in a modified version of the client image 22 produced by the client image generator 284 based on the position of the target display area 21 within the host image 20. The modified version of the client image 22 can be sent to and received by the client image processor 277, and displayed within the display 212 of the client device 200. Accordingly, the client image 22 displayed within the display 212 can be modified (e.g., replaced, updated) in response to an input value. Updating of a client image in response to an input value is also illustrated in FIGS. 3A through 3D.

FIG. 3C illustrates a host image 30B that is modified relative to the host image 30A shown in FIG. 3A in response to input from a user. The host image 30B shown in FIG. 3C can be an image that is produced after the host image 30A shown in FIG. 3A. Specifically, a field 39, which included the letter “A” in host image 30A shown in FIG. 3A, is modified via an input device (e.g., the input device 242 shown in FIG. 2) to include the text “A-15” as shown in FIG. 3B. In some embodiments, the host image 30B can be produced in response to the modification of the field 39 represented within the host image 30A.

Because the field 39, in this embodiment, is included in the target display area 31, the updated field 39 is included in client image 32B shown in FIG. 3D, which is produced based on the target display area 31 within the host image 30B shown in FIG. 3C. Thus, the updated field 39 in the host image 30B can be displayed at a client device via the client image 32B.

Although not shown in FIGS. 3A through 3F, an updated client image can be produced based on changes triggered by an application without an input triggered by a user. For example, an application playing a video can produce a stream of host images that are updated as the video proceeds. Accordingly, client images produced based on the stream of host images will also be updated as the host images within the stream of host images are updated.

Referring back to FIG. 2, the client device 200 and the host device 250 each include a movement module. Specifically, the client display module 210 includes a client target movement module 235, and the host display module 215 includes a host target movement module 245. The client target movement module 235 is configured to trigger movement of the target display area 21 within the host display area 23 via the host target movement module 245. For example, the client target movement module 235 can be configured to define an indicator configured to trigger movement of the target display area 21. The indicator can be sent (via a client-host session) from the client target movement module 235 to the host target movement module 245. The host target movement module 245 can be configured to trigger movement of the target display area 21 at the host device 250 within the host display area 23 based on the indicator.

In some embodiments, the indicator can be, or can include, coordinates (which can be restored to as target coordinates) specifying a position of the target display area 21 within the host display area 23. In some embodiments, the indicator can be, or can include, an offset from a prior position of the target display area 21 within the host display area 23 to a new position of the target display area 21 within the host display area 23. In some embodiments, the indicator can be, or can include, a vector specifying a direction and magnitude of the change in a position of the target display area 21 within the host display. 23.

In some embodiments, movement of the target display area 21 within the host display area 23 can be triggered using one or more input devices. For example, movement of the target display area 21 can be triggered by a mouse device and/or a keyboard device (which can be types of the input device 242). In some embodiments, movement of the target display area 21 can be triggered using a touch sensitive portion of the display 212.

Movement of a target display area within a host display area is illustrated in connection with FIGS. 3C through 3F. FIG. 3E illustrates the target display area 31 moved to the right to a position at target coordinates (4,4) within the host display area 33 of the host image 30B from a position at target coordinates (3,4) shown in FIG. 3C. In some embodiments, the target display area 31 can be moved in response to an input from a user (via the client target movement module 235 and the host target movement module 245 shown in FIG. 2). In this embodiment, the target display area 31 is moved within the host display area 33 without a change in the host image 30B. Specifically, the host image 30B shown in FIG. 3E is the same as the host image 30B shown in FIG. 3C. In some embodiments, the target display area 31 can be moved within the host display area 33 with (e.g., coincident with) a change in a host image associated with the host display area 33.

FIG. 3F illustrates a client image 32C that corresponds with the position of the target display area 31 shown in FIG. 3E. Accordingly, the client image 32C can be an image displayed at a client device after movement of the target display area 31 within the host display area 33. In some embodiments, the client image 32C can be produced by the client image generator 284, and received by the client image processor 277 shown in FIG. 2.

Referring back to FIG. 2, the client display module 210 includes a client connection module 230 configured to establish at least a portion of a client-host session (e.g., a moving window session) between the client device 200 and the host device 250. Similarly, the host display module 215 includes a host connection module 237 configured to establish at least a portion of a connection between the client device 200 and the host device 250. In some embodiments, the connection between the client device 200 and host device 250 during a client-host session can be a wireless connection, a wired connection, a peer-to-peer connection, a network connection, a secure connection, an encrypted connection, and/or so forth.

In some embodiments, the client connection module 230 and the host connection module 237 are configured to exchange parameter values related to establishment of a client-host session (e.g., a moving window session). In some embodiments, the parameter values related to establishment of client-host session can be referred to as startup parameter values or as initialization parameter values.

For example, the host connection module 237 can be configured to send an indicator (e.g., a parameter value) to the client connection module 230 that the host display module 215 is configured (e.g., enabled) or not configured (e.g., not enabled) to support display of less than all of the host display area 23 associated with the application 26. In other words, the host connection module 237 and the client connection module 230 can be configured to exchange parameter values indicating capability to communicate via a moving window session.

In some embodiments, the client connection module 230 and the host connection module 237 can be configured to exchange parameter values related to initialization of host display area (also can be referred to as host display area parameter values). Specifically, the host connection module 237 can be configured to send parameter values related to initialization of the host display area 23 to the client connection module 230. In some embodiments, parameter values about the host display area 23 can be requested from the host connection module 237 by the client connection module 230. For example, the host connection module 237 can be configured to send an indicator (e.g., a parameter value) of dimensions (e.g., a size, an area, an aspect ratio, height/width values), resolution, and/or so forth of the host display area 23. In some embodiments, the host connection module 237 can be configured to send parameter values about a grid size, a coordinate system, an origin, and/or so forth of the host display area 23 to be used when specifying movement of the target display area 21 within the host display area 23.

In some embodiments, the client connection module 230 and the host connection module 237 can be configured to exchange parameter values related to initialization of the target display area 21 (also can be referred to as target display area parameter values). For example, the client connection module 230 can be configured to define and send an initial position value(s) (e.g., an initial location, an initial offset) for the target display area 21 to the host connection module 237, or vice versa. The initial position value(s) can specify, for example, an initial position of the target display area 21 within the host display area 23. In some embodiments, the initial position value(s) can be, or can include, for example, target coordinates of an initial position of the target display area 21 with respect to an origin of the host display area 23. In some embodiments, the initial position value(s) can be specified based on parameter values about (e.g., specifying) the host display area 23 to the client connection module 230 from the host connection module 237.

As another example, the client connection module 230 can be configured to send an indicator (e.g., a parameter value) of dimensions (e.g., a size, an aspect ratio, an area, height/width values), resolution, and/or so forth of the target display area 21 for initialization of the target display area 21. In some embodiments, parameter values about the target display area 21 can be requested from the client connection module 230 by the host connection module 237. In some embodiments, the dimensions of the target display area 21 can be relative to the dimensions of the host display area 23. For example, the target display area 21 can be defined as a percentage of an area of the host display area 23. Accordingly, the target display area 21 can be defined based on parameter values about the host display area 23.

In some embodiments, the client connection module 230 and the host connection module 237 can be configured to exchange parameter values, such as dimensions (e.g., a size, an area, an aspect ratio, height/width values), resolution, and/or so forth of the display 212 of the client device 200 to the host connection module 237. In some embodiments, parameter values related to the display 212 can be referred to as to display values. The display values can be used by the host connection module 237 to define a size of the target display area 21 within the host display area 23. In some embodiments, the target display area 21 can have an area (e.g., dimensions) and/or resolution that are different than those of the display 212.

In some embodiments, the client connection module 230 in the host connection module 237 can be configured to exchange parameter values related to codecs to be used during a client-host session. For example, the host connection module 237 can be configured to send a parameter value identifying an encoding algorithm (also can be referred to as an encode parameter value) to be used by the encoder 286 to encode images during a client-host session. The client connection module 230 can be configured to acknowledge the encoding algorithm, and can be configured to trigger the decoder 272 to compatibly decode images based on the encoding algorithm during the client-host session. As another example, the client connection module 230 can be configured to send a parameter value identifying a decoding algorithm (also can be referred to as a decode parameter value) to be used by the decoder 272 to decode images during a client-host session. The host connection module 237 can be configured to acknowledge the decoding algorithm, and can be configured to trigger the encoder 286 to encode images compatibly with the decoding algorithm during the client-host session.

In some embodiments, parameter values related to establishment of the client-host session between the client device 200 and the host device 250 can be based on one or more default parameter values (e.g., default settings). For example, the client connection module 230 can be configured to define and send a default initial position value(s) (e.g., an initial location, an initial offset) for the target display area 21 to the host connection module 237, or vice versa.

In some embodiments, one or more parameter values related to initialization can be used to determine, for example, a position of cursor, selection, and/or so forth triggered by an input device (e.g., a cursor device, a mouse device, a touchscreen device) in the host display area. For example, a parameter value identifying an origin with respect to the host display area 23 can be used to identify or define coordinates related to a cursor triggered by an input device.

In some embodiments, one or more parameter values related to a client-host session can be modified after a client-host session has been established. In other words, one or more parameter values related to the client-host session can be modified during the client-host session. For example, dimensions of the target display area 21 can be modified (e.g., increased, decreased) during a client-host session. In some embodiments, codecs used by the encoder 286 and/or the decoder 272 can be modified during a client-host session.

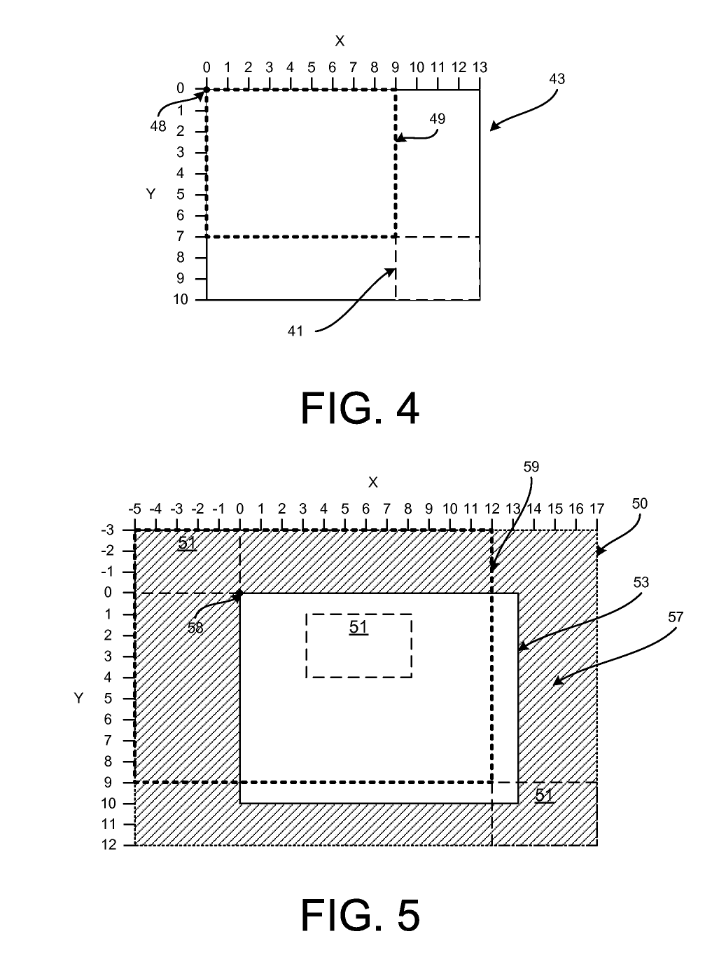

FIG. 4 is a diagram that illustrates an example of an offset boundary 49 within a host display area 43 and related to a target display area 41. As shown in FIG. 4, an origin of the host display area 43 is at x-y coordinates (0,0) (represented by reference numeral 48) and the host display area 43 has a width of 13, and a height of 10.

In this embodiment, a position of the target display area 41 within the host display area 43 is based on a position of an upper-left corner of the target display area 41 and coordinates with respect to the origin 48 of the host display area 43. As mentioned above, coordinates that are used to define a position of the target display area 41 within the host display area 43 can be referred to as target coordinates. For example, the target display area 41, as shown in FIG. 4, is located at target coordinates (9,7).

As shown in FIG. 4, the offset boundary 49 (illustrated by a dashed rectangle) is defined by offset boundary values that can include coordinates with an x-value between 0 and 9 (which can be referred to as a maximum horizontal width) and with a y-value between 0 and 7 (which can be referred to as a maximum vertical height). The offset boundary 49 defines a boundary (e.g., a vertical boundary, horizontal boundary) of target coordinates for the target display area 41. In some embodiments, the offset boundary 49 can be defined by offset boundary values that are different than x-y coordinates (e.g., perimeter values, etc.).

In this embodiment, the offset boundary 49 is defined so that the target display area 41 may only be positioned with respect to the host display area 43 based on coordinates that fall within the offset boundary 49. As shown in FIG. 4, the location of the target display area 41 with coordinates (9,7) falls within the offset boundary 49.

In this embodiment, the offset boundary 49 is defined so that the target display area 41 will be included within the host display area 43 so long as target coordinates associated with the target display area 41 are included in the offset boundary 49. For example, if the target display area 41 is located at target coordinates (0,7) (which are coordinates included in the offset boundary 49), the target display area 41 will be included in the host display area 43.

FIG. 5 is a diagram that illustrates an example of another offset boundary 59 associated with a host display area 53 and related to a target display area 51. As shown in FIG. 5, an origin of the host display area 53 is at x-y coordinates (0,0) (represented by reference numeral 58) and the host display area 53 has a width of 13, and a height of 10 (as illustrated by the x-y coordinates).

In this embodiment, a position of the target display area 51 within the host display area 53 is based on a position of an upper-left corner of the target display area 51 and coordinates with respect to the origin 58 of the host display area 53. As mentioned above, coordinates that are used to define a position of the target display area 51 within the host display area 53 can be referred to as target coordinates. In this embodiment, the target display area 51 is illustrated at several different target coordinates. For example, the target display area 51 is illustrated at target coordinates (−5,−3), is illustrated at target coordinates (12,9), and is also illustrated at target coordinates (3,1). Although not explicitly identified, the target display area 51 can be located at these different (e.g., distinct) target coordinates during different (e.g., mutually exclusive) time slices.

As shown in FIG. 5, the offset boundary 59 (illustrated by a dashed rectangle) is defined by offset boundary values that can include coordinates with an x-value between −5 and 12 (which can be referred to as a maximum horizontal width) and with a y-value between −3 and 9 (which can be referred to as a maximum vertical height). The offset boundary 59 defines a boundary (e.g., a vertical boundary, a horizontal boundary) of target coordinates for the target display area 51. In some embodiments, the offset boundary 59 can be defined by offset boundary values that are different than x-y coordinates (e.g., perimeter values, etc.). In some embodiments, the offset boundary 59 can be defined different than shown in FIG. 5. For example, the offset boundary 59 can be defined so that target display area 51 can be moved entirely outside of the host display area 53 on the right side (with a maximum offset boundary value of 13).

In this embodiment, the offset boundary 59 is defined so that in some instances the target display area 51 can be positioned outside of the host display area 53 based on coordinates that fall within the offset boundary 59. Accordingly, the target display area 51 can have an area that is moved within a boundary 50 that includes area 57 (illustrated by slanted lines) and the host display area 53. In some embodiments, the area 57 can include, for example, a background image (e.g., a black background image, a white background image), a customized image, and/or so forth. In some embodiments, the boundary 50 can be referred to as a boundary of movement of the target display area 51.

As shown in FIG. 5, the location of the target display area 51 with target coordinates (−5,−3) falls within the offset boundary 59, but is entirely outside of the host display area 53. When the target display area 51 is located at target coordinates (−5,−3), a client image corresponding with the target display area 51 can be defined based on an image of at least a portion of area 57. When the location of the target display area 51 is at target coordinates (3,1) within the offset boundary 59, the target display area 51 is entirely inside of the host display area 53. In such instances, a client image associated with the target display area 51 at the target coordinates (3,1) can be based on a host image of the target display area 53. Finally, when the location of the target display area 51 is at target coordinates (12,9) within the offset boundary 59, a portion of the target display area 51 is inside of the host display area 53 and a portion of the target display area 51 is outside of the host display area 53. In such instances, a client image associated with the target display area 51 at the target coordinates (12,9) can be based on a combination of a host image (or a portion thereof) of the target display area 53 and an image of at least a portion of the area 57.

In some embodiments, a client image can be defined so that as many visible pixels as possible from the host display area 53 can be sent to a client device when part of the target display area 51 is outside the host display area 53. In this use case, a user can use, for example, a scrollbar to control a position of the target display area 51. In this scenario, the range of offset can be calculated based on the following:

offset_{—}x_min=0;

offset_{—}x_max=max(0,host_display_area_width−target_display_area_width);

offset_{—}y_min=0;

offset_{—}y_max=max(0 host_display_area_height−target_display_area_height);

When the requested target offset coordinates are outside of this range, the target coordinates of the target display area 51 can be adjusted according to the following:

visible_offset_{—}x=min(max(offset_{—}x,offset_{—}x_min),offset_{—}x_max);

visible_offset_{—}y=min(max(offset_{—}y,offset_{—}y_min),offset_{—}y_max);

Then the size (e.g., dimensions) of visible area (e.g., client image) within the target display area 51 can be calculated as:

visible_width=min(target_display_area_width,host_display_area_width−visible_offset_{—}x);

visible_height=min(target_display_area_height,host_display_area_height−visible_offset_{—}y).

In some embodiments, the requested target coordinates can be given priority. In this scenario, the visible area size of the host display area 53 can be determined based on requested target offset coordinates. The visible area size can vary, especially when the requested target offset coordinates are close to the border of the host display area 53. In this use case a user can use, for example, a scrollbar to control a position of the target display area 51. In this scenario, the range of offset can be unlimited and can be based on the following:

visible_offset_{—}x=min(max(offset_{—}x,0),host_display_area_width);

visible_offset_{—}y=min(max(offset_{—}y,0),host_display_area_height);

Then the size (e.g., dimensions) of visible area (e.g., client image) can be calculated as:

visible_right=min(max(offset_{—}x+target_display_area_width,0),host_display_area_width);

visible_bottom=min(max(offset_{—}y+target_display_area_height,0),host_display_area_height);

visible_width=max(visible_right−visible_offset_{—}x,0);

visible_height=max(visible_bottom−visible_offset_{—}y,0);

After the visible area has been calculated, the host device can encode the pixel data in visible area as a series of client images (e.g., a video frame sequence) and can transmit them to client device. In some embodiments, an anchor frame or anchor client image (which can be a first image) of the series of client images can be associated with (e.g., can include) the information about the visible area (visible_offset_x, visible_offset_y, visible_width and visible_height). In some embodiments, one or more of the formulas (e.g., algorithms) described above can be defined within, or can be selected within, initialization parameters (e.g., initialization parameters associated with offset boundaries) exchanged during establishment of a client-host session.

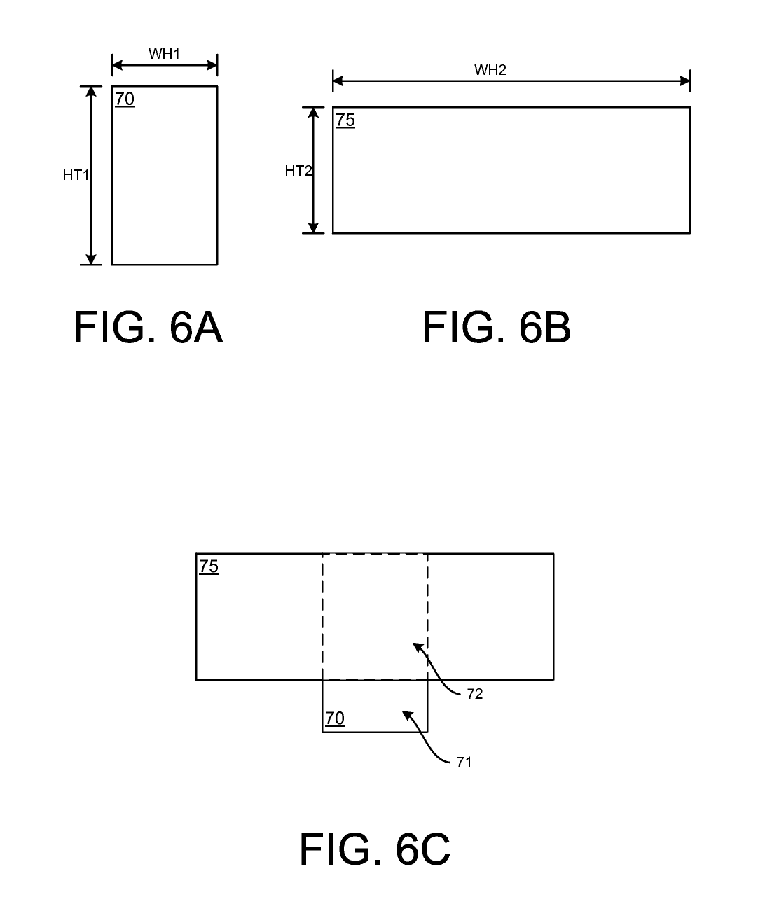

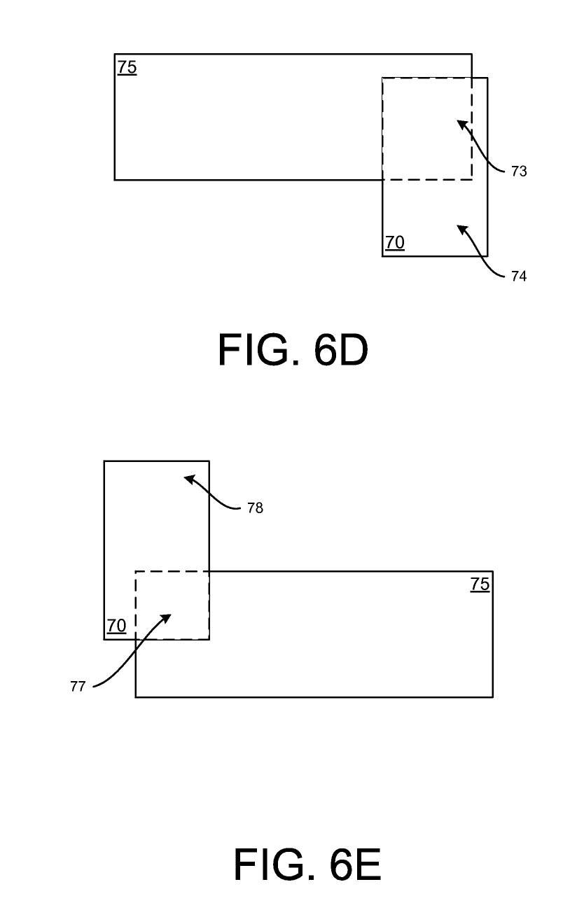

FIG. 6A through 6E illustrate a target display area 70 and a host display area 75 that have different aspect ratios. As shown in FIG. 6A, the target display area 70 has an aspect ratio where a height HT1 is greater than a width WH1, and as shown in FIG. 6B, the host display area 75 has an aspect ratio where a height HT2 is less than a width WH2. In this embodiment, the height HT2 of the host display area 75 is smaller than the height HT1 of the target display area 70. Also, in this embodiment, the width WH1 of the target display area 70 is smaller than the width WH2 of the host display area 75.

Because the aspect ratios of the target display area 70 and the host display area 75 in this embodiment are different, only a portion of the target display area 70 can overlap with the host display area 75. Although not shown, even though a target display area may have an aspect ratio different than an aspect ratio of a host display area, the target display area can be entirely disposed within the host display area.

FIG. 6C is a diagram that illustrates an overlap between the target display area 70 and the host display area 75. As shown in FIG. 6C, a portion 72 of the target display area 70 and the host display area 75 overlap, and a portion 71 of the target display area 70 is disposed outside of the host display area 75. In this embodiment, a client image can be produced, at least in part, based on the overlapping portion 72 between the target display area 70 and the host display area 75.

FIG. 6D is another diagram that illustrates an overlap between the target display area 70 and the host display area 75. As shown in FIG. 6D, a portion 73 of the target display area 70 and the host display area 75 overlap, and a portion 74 of the target display area 70 is disposed outside of the host display area 75. In this embodiment, a client image can be produced, at least in part, based on the overlapping portion 73 between the target display area 70 and the host display area 75.

FIG. 6E is yet another diagram that illustrates an overlap between the target display area 70 and the host display area 75. As shown in FIG. 6E, a portion 77 of the target display area 70 and the host display area 75 overlap, and a portion 78 of the target display area 70 is disposed outside of the host display area 75. In this embodiment, a client image can be produced, at least in part, based on the overlapping portion 77 between the target display area 70 and the host display area 75.

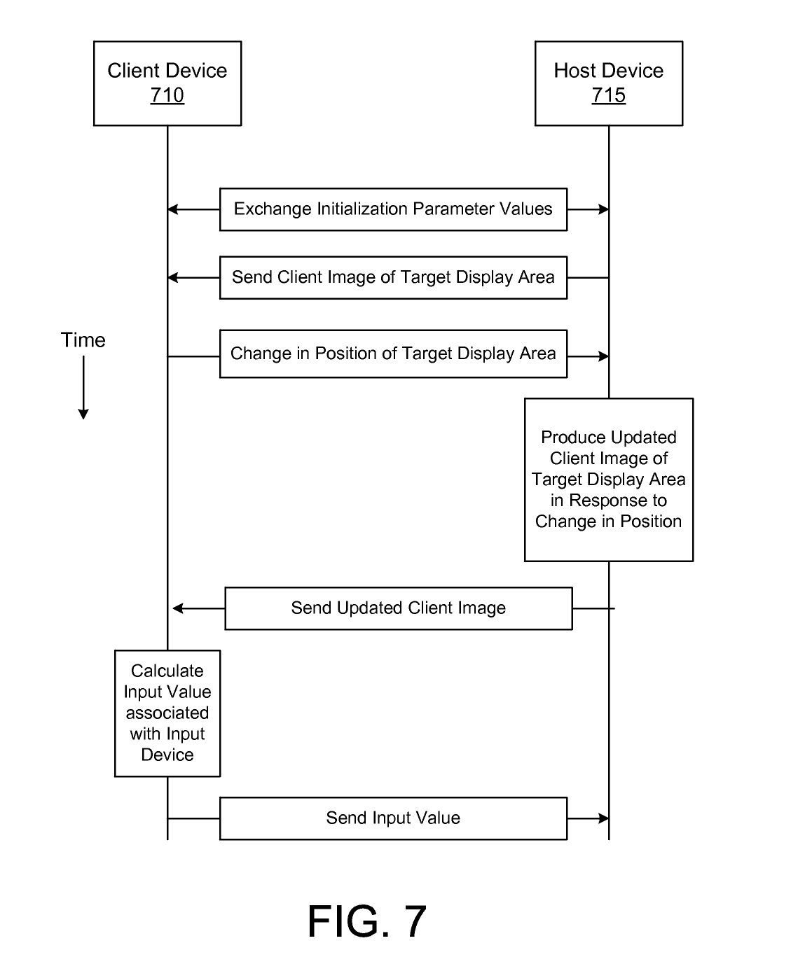

FIG. 7 is a timing diagram that illustrates communication between a client device 710 and a host device 715 during a client-host session associated with a moving window. In some embodiments, the client device 710 can include a client display module such as the client display module 210 shown in FIG. 2. Similarly, the host device 715 can include a host display module such as the host display module 215 shown in FIG. 2.

As shown in FIG. 7, initialization parameter values (also can be referred to as startup parameter values) are exchanged between the client device 710 and the host device 715. The initialization parameter values can be exchanged as a client-host session established between the client by 710 and the host device 715 based on, for example, the exchange of credentials, login information, password information, and/or so forth. In some embodiments, the initialization parameter values can be exchanged between the client connection module 230 and the host connection module 237.

In some embodiments, the initialization parameter values can include dimensions related to a host display and/or a client display. In some embodiments, the initialization parameter values can include, for example, values related to an offset boundary, such as those described in connection with FIGS. 4 through 6, during establishment of a client-host session (e.g., a moving window session). In some embodiments, the initialization parameter values can include initial (or default) position values related to an initial target position (e.g., an initial location, an initial offset) of a target display area within a host display area.

In some embodiments, values related to, for example, an offset boundary, an initial position, and/or so forth can be included in a boundary preference. As shown in FIG. 2, a boundary preference 24 can be stored in a client memory 220 of the client display module 210. Accordingly, values defining the boundary preference 24 can be exchanged during the exchange of initialization parameter values (which can occur during establishment of a client-host session).

In some embodiments, a target display area, a host display area, an offset boundary, and/or so forth may have a shape different than a square or a rectangle. In some embodiments, a target display area, a host display area, an offset boundary, and so forth can have a circular shape, a curved shape, a triangular or other polygon shape, and/or so forth.

In some embodiments, one or more values related to a boundary (e.g., values of an offset boundary) can be modified during a client-host session after the client-host session has been established. For example, one or more values defining an offset boundary, a host display area, an origin of a boundary, and/or so forth, can be exchanged as initialization parameter values during establishment of a client-host session. After the client-host session has been established, one or more of the values associated with the boundary can be modified at the client device 710 and/or at the host device 715. As a specific example, one or more values defining the offset boundary can be modified in response to a target display area being modified (e.g., decreased in area, increase in area, modified in dimensions, modified and aspect ratio).

As shown in FIG. 7, after initialization parameter values been exchanged, a client image of a target display area is sent from the host device 715 to the client device 710. In some embodiments, the client image can be based on an initial position of the target display area within a host display area. In some embodiments, a series of client images (e.g., an ordered sequence of client images) associated with the initial position of the target display area within the host display area can be streamed from the host device 715 to the client device 710. In some embodiments, an offset of the client image within the host display area can be associated with, or included with, the client image when sent from the host device 715 to the client device 710.

As shown in FIG. 7, an indicator of a change in the position of the target display area is sent from the client device 710 and the host device 715. In some embodiments, the change in the position of the target display area can be triggered via an input device associated with the client device 710. In response to the indicator of the change in the position of the target display area, an updated client image of the target display area is produced and sent from the host device 715 to the client device 710.

Also as shown in FIG. 7, an input value associated with an input device (e.g., a mouse device, a keyboard device, a touchpad device, a touchscreen device) is calculated (e.g., determine) at the client device 710. The input value of the input device is calculated and sent from the client device 710 to the host device 715. In some embodiments, the input value of the input device can be, for example, a position of a cursor (e.g., a position with respect to a host display area, a client image, a target display area), a change in an input value associated with an input device, and/or so forth. In some embodiments, an updated client image can be defined and sent from the host device 715 to the client device 710 in response to the input value associated with the input device being received at host device 715.

In some embodiments, a position of the cursor (which can be an input value associated with an input device) with respect to a client image, a target display area, the host image, a host display area (e.g., within the host display area outside of the client image), and/or so forth, can be calculated (e.g., determined) at the client device 710 and/or at the host device 715. In some embodiments, the position of the cursor can be defined with respect to an origin of the host display area (and/or host image), an origin of a target display area (and/or client image), and/or so forth. The position of the cursor can be defined so that movements of the cursor can be calculated at the client device 710 and/or at the host device 715.

For example, a position of a cursor (within a host display area, a client image) can be determined at the client device 710 based on an indicator of an origin associated with the host display area received at the client device from the host device 715. The position of the cursor based on coordinates associated with the host display area can then be sent from the client device 710 to the host device 715. As another example, a position of the cursor within a client image (and/or a target display area) can be determined that the client device 710 based on an origin of the client image (and/or the target display area). The position of the cursor with respect to the origin of the client image (and/or the target display area) can be sent from the client device 710 to the host device 715. Based on position of the cursor with respect to the origin of the client image (and/or the client display area), the host device 715 can calculate the position of the cursor with respect to a host image (and/or a host display area).

The timeline illustrated in FIG. 7 is presented by way of example. Although not shown, in some embodiments, input values associated with input devices can be sent from the client device 710 and the host device 715 at any point within a timeline of exchanges between the client device 710 and the host device 715. Also, a position of a target display area can be changed multiple times for an updated client images sent from the host device 715 to the client device 710. In some embodiments, multiple updated client images (e.g., multiple updated client images associated with a video being played at the host device 715) can be produced and sent from the host device 715 to the client device 710 while the target display area is at a single position (e.g., while the target display area has not changed position).

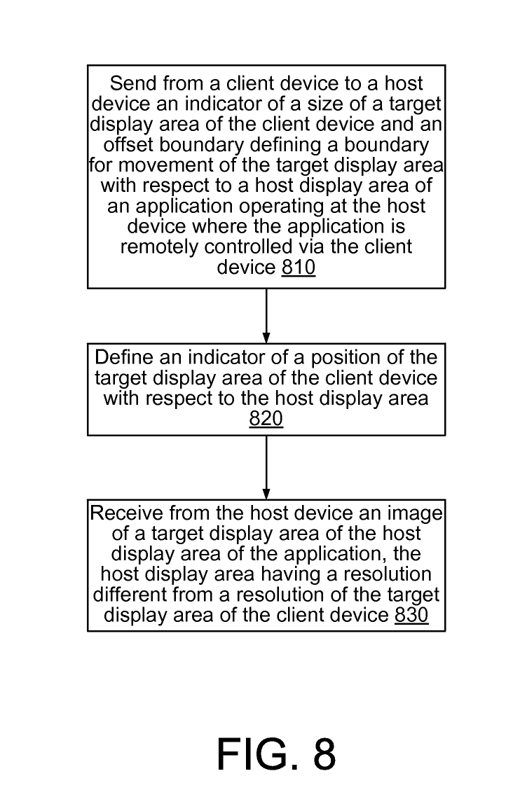

FIG. 8 is a flowchart that illustrates a method for processing images at a client device remotely controlling an application operating at a host device, according to embodiment. At least some portions of the flowchart can be performed by a client device and/or a host device such as those shown in FIG. 2.

An indicator of a size of a target display area of a client device and an offset boundary defining a boundary limiting movement of the target display area with respect to a host display area of an application operating at a host device is sent from the client device to the host device where the application is remotely controlled via the client device (block 810). In some embodiments, the indicator of the size of the target display area and the offset boundary defining the boundary limiting movement of the target display area can be sent from the client connection module 230 of the client device 200 shown in FIG. 2. In some embodiments, the offset boundary can be defined using one or more initialization parameter values. In some embodiments, the offset boundary can have a maximum length (e.g., a maximum width, a maximum height).

An indicator of a position of the target display area of the client device is defined with respect to the host display area (block 820). In some embodiments, the position of the target display area can be defined by the client target movement module 235 of the client device 200 shown in FIG. 2. In some embodiments, the indicator can be an indicator of a change of the position of the target display area.

An image of a target display area of the host display area of the application is received from the host device where the host display area has a resolution different from a resolution of the target display area of the client device (block 830). In some embodiments, the image of the target display area can be received by the client image processor 277 of the client device 200 shown in FIG. 2. In some embodiments, the image of the target display area can be a client image triggered for display at the client device.

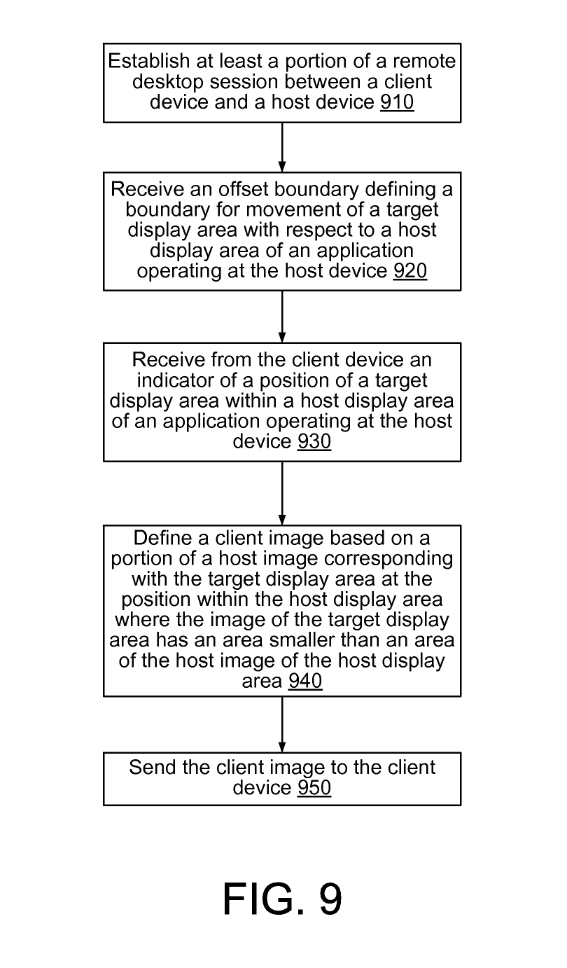

FIG. 9 is a flowchart that illustrates a method for processing images related to a client-host session, according to embodiment. At least some portions of the flowchart can be performed by a client device and/or a host device such as those shown in FIG. 2.

At least a portion of a remote desktop session between a client device and a host device is established (block 910). In some embodiments, the portion of the remote desktop session can be established via the client connection module 230 of the client device 200 and the host connection module 237 of the host device 250 shown in FIG. 2.

An offset boundary defining a boundary for movement of a target display area with respect to a host display area of an application operating at the host device is received (block 920). In some embodiments, the offset boundary defining the boundary for movement of the target display area can be received at the host connection module 237 of the host device 250 from the client connection module 230 of the client device 200 shown in FIG. 2. In some embodiments, the offset boundary can be defined using one or more initialization parameter values. In some embodiments, the offset boundary can have a maximum length (e.g., a maximum width, a maximum height).

An indicator of a position of a target display area within a host display area of an application operating at the host device is received from the client device (block 930). In some embodiments, the position of the target display area can be received at the host target movement module 245 of the host device 250 from the client target movement module 235 of the client device 200 shown in FIG. 2. In some embodiments, the indicator can be an indicator of a change of the position of the target display area.

A client image is defined based on a portion of a host image corresponding with the target display area at the position within the host display area where the image of the target display area has an area smaller than an area of the host image of the host display area (block 940), and the client image is sent to the client device (block 950). In some embodiments, the client image can be defined by the client image generator 284 of the host device 250 shown in FIG. 2. In some embodiments, the client image can be encoded by the encoder 286 of the host device 250 shown in FIG. 2 before being sent to the client device.

As discussed above in connection with FIG. 2, the client device 200 and the host device 250 each include a movement module. The client target movement module 235 is configured to trigger movement of the target display area 21 within the host display area 23 via the host target movement module 245. For example, the client target movement module 235 can be configured to define an indicator configured to trigger movement of the target display area 21. The indicator can be sent (via a client-host session) from the client target movement module 235 to the host target movement module 245. The host target movement module 245 can be configured to trigger movement of the target display area 21 at the host device 250 within the host display area 23 based on the indicator of the movement.

In response to an indicator of movement of the target display area 21 within the host display area 23, the client image generator 284 can be configured to produce and send an updated client image (or portion thereof) (not shown) based on the host image 20 or an updated host image (not shown). For example, the target display area 21 can have a first position within the host display area 23 as shown in FIG. 2. Based on the first position of the target display area 21 within the host display area 23, the client image 22 (which corresponds with the first position of the target display area 21 and can be produced by the client image generator 284 from the host image 20) can be received at the client device 200 by the client image processor 277 and displayed within the display 212 by the client display manager 244. The client target movement module 235 can be configured to trigger an indicator of movement of the target display area 21 from the first position to a second position within the host display area 23. The movement can be triggered by for example, the input device 242, and the indicator of movement can be received at the host target movement module 245. An updated client image (not shown) can be produced based on the second position of the target display area 21 within the host display area 23 by the client image generator 284, and the updated client image can be sent to the client device 200. In some embodiments, the updated client image can be based on the host image 20 or based on an updated host image (not shown). In some embodiments, the client image 22 being displayed in the display 212 can be referred to as a current client image. A client image previously displayed in the display 212 (before the current client image) can be referred to as a prior client image, and the updated client image being sent from the host device 250 to the client device 200 as an update to the current image can also be referred to as subsequent image.

In some embodiments, similar to the client image 22, the updated client image can be encoded at the host device 250 by the encoder 286 (e.g., from a bitmap image to a compressed image) before being sent to the client device 200. Accordingly, the updated client image that has been encoded can be decoded at the client device 200 by the decoder 272 before being displayed in the display 212. Also, in some embodiments, the host image 20 can be encoded at the host device 250 by the encoder 286 before being sent to the client device 200 for storage as a copied host image 20′ (also can be referred to as a copy of the host image 20). The copied host image 20′ that has been encoded can be decoded at the client device 200 by the decoder 272 before the copied host image 20′ (or portions thereof) is displayed in the display 212.

In this embodiment, the host display module 215 of the host device 250 is configured to send a copy of the host image 20 to and stored at the client display module 210 of the client display device 200 as a copied host image 20′. As shown in FIG. 2, in some embodiments, the copied host image 20′ can be referred to as a full scope image of the host image 20. In some embodiments, the copied host image 20′ can be stored in the client memory 220. The copied host image 20′ can be sent to and stored at the client display module 210 of the client display device 200 so that the copied host image 20′ (or portions thereof) can be used in response to movement of the target display area 21 within the host display area 23. Specifically, portions of the copied host image 20′ stored at the client display device 200 can be used to update a current (or prior) client image in response to a change in position of the target display area 21 in a relatively rapid fashion. In some embodiments, portions of the copied host image 20′ stored at the client display device 200 can be used to update a current (or prior) client image in the event that an updated (or subsequent) client image (or portion thereof) from the host device 250 is delayed.

In some embodiments, a client image that is updated based on a copied host image 20′ can be referred to as a transition image. The transition image can function as a temporary updated client image until an updated client image is received from the host device 250 at the client device 200. As shown in FIG. 2, the image receiver 270 of the client display module 210 includes a transition image module 279 configured to produce one or more transition images based on combinations of a client image (e.g., client image 22) and a copied host image (e.g., copied host image 20′). The transition image can correspond with an updated position of the target display area 21. The updated position of the target display area 21 may cover (e.g., capture) new areas within the host display area 23 that are outside of an area covered by a current (or prior) client image. Because the target display area 21 at the updated position may cover new areas that are outside of the client image, the transition image can function as a temporary updated client image that includes valid portions of the current client image and new areas within the target display area 21 at the updated position can be filled in with portions of the copied host image. Specifically, the transition image can be defined by the transition image module 279 based on portions of a client image that correspond with an updated position of the target display area 21 (and will exclude portions of the client image that are outside of the updated position of the target display area 21) and portions of a copied host image that correspond with the updated position of the target display area (and are not covered by the client image).

In some embodiments, a transition image, which can be triggered for display as a client image, can have an aspect ratio different than an aspect ratio of the copied host image 20′ (and/or the host image 20) (such as the aspect ratios shown, for example, in connection with FIGS. 6A through 6E). In some embodiments, the transition image can be defined based on initialization parameter values (e.g., offset boundary values, dimension values, default initial position values, offset values) exchanged during establishment of client host session such as those described in connection with, for example, FIGS. 4 through 9. Accordingly, in some embodiments, the target display area 21 and/or the transition image can include at least some portions of an area (e.g., a background image) outside of the copied host image 20′ (and/or the host image 20). More details related to transition images are described below.

As a specific example, the target display area 21 can have a first position within the host display area 23 as shown in FIG. 2. Based on the first position of the target display area 21 within the host display area 23, the client image 22 (which corresponds with the first position of the target display area 21 and can be produced by the client image generator 284 from the host image 20) can be received at the client device 200 by the client image processor 277 and displayed within the display 212 by the client display manager 244. Also, a copy of the host image 20 can be sent by the host image generator 282 to the host image processor 278 of the client device 200 and can be stored as copied host image 20′ at the client device 200. The client target movement module 235 can be configured to trigger an indicator of movement of the target display area 21 from the first position to a second position within the host display area 23. The movement can be triggered by for example, the input device 242, and the indicator of movement can be received at the host target movement module 245. The movement of the target display area 21 can cover at least a portion of an area included in the client image 22, but may cover a new area that is not covered by a relatively recent prior client image or current client image.

In this example, the transition image module 279 can be configured to define a transition image that corresponds with the second position of the target display area within the host display area 23. The transition image can include a combination of portions of the client image 22 that correspond with the second position of the target display area 21 (and will exclude portions of the client image 22 that are outside of the second position of the target display area 21) and portions of the copied host image 20′ that correspond with the updated position of the target display area (and are not covered by the client image). Specifically, because the target display area 21 at the updated position covers new area outside of the client image 22, the transition image can function as a temporary updated client image that includes valid portions of the client image 22 and the new area within the target display area 21 at the updated position can be filled in with portions of the copied host image 20′. Accordingly, the transition image can approximate an updated client image (not shown and not yet received) corresponding with the second position of the target display area 21 within the host display area 23. The transition image can be defined by the transition image module 279 before the updated client image is produced based on the second position of the target display area 21 within the host display area 23 and sent to the client device 200.

In some embodiments, processing delays, bandwidth issues associated with a communication link between the client device 200 and host device 250, differences in timing of processing, and/or so forth can result in an updated client image being sent from the host device 250 to the client device 200 with an undesirable delay. For example, a round-trip delay between the client device 200 and the host device 250 caused by limited network bandwidth between the client device 200 and host device 250 can result in an undesirable delay between receiving an indicator of a movement of the target display area 21 at the host device 250 and sending of an updated client image to the client device 200 in response to the indicator of the movement of the target display area 21. Such undesirable delay can result in relatively slow updates at the display 212 in response to movement of the target display area 21 within the host display area 23. In such instances, one or more transition images can be produced by the transition image module 279 and displayed within the display 212 until an updated client image is received.

In some embodiments, a transition image produced by the transition image module 279 can be replaced by an updated client image upon receipt of the client image at the client image processor 277. In some embodiments, multiple transition images can be produced by the transition image module 279 and displayed at the client device 200 until an updated client image is received. In some embodiments, a transition image may not be produced by the transition image module 279 if an updated client image is received in a timely fashion (e.g., within a threshold period of time, before the transition image is displayed at the display 212).

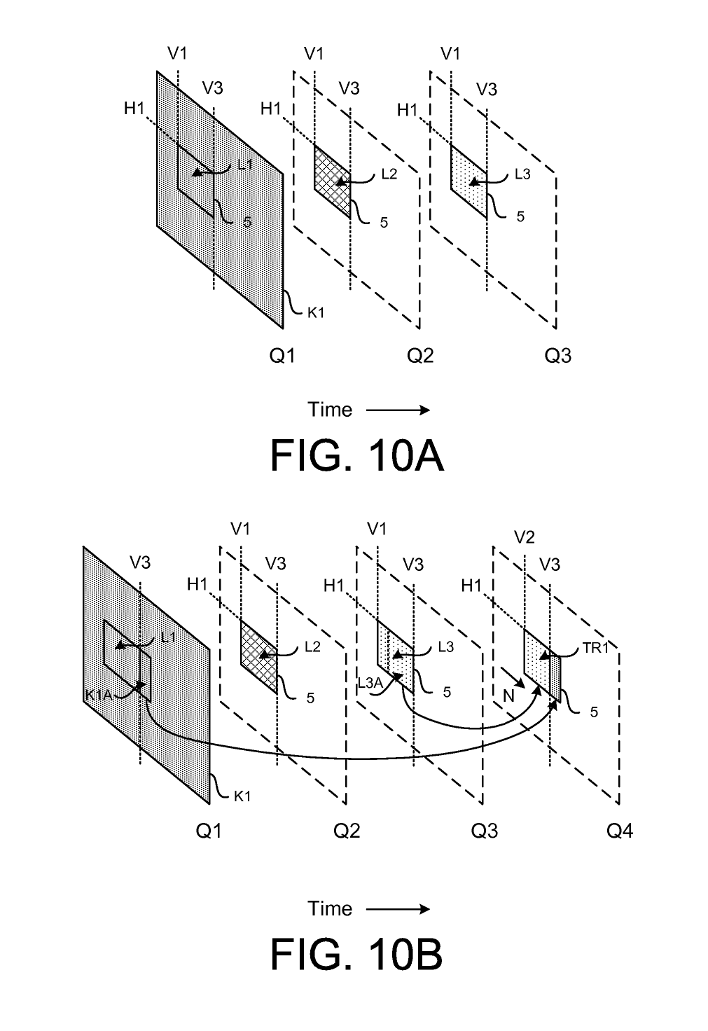

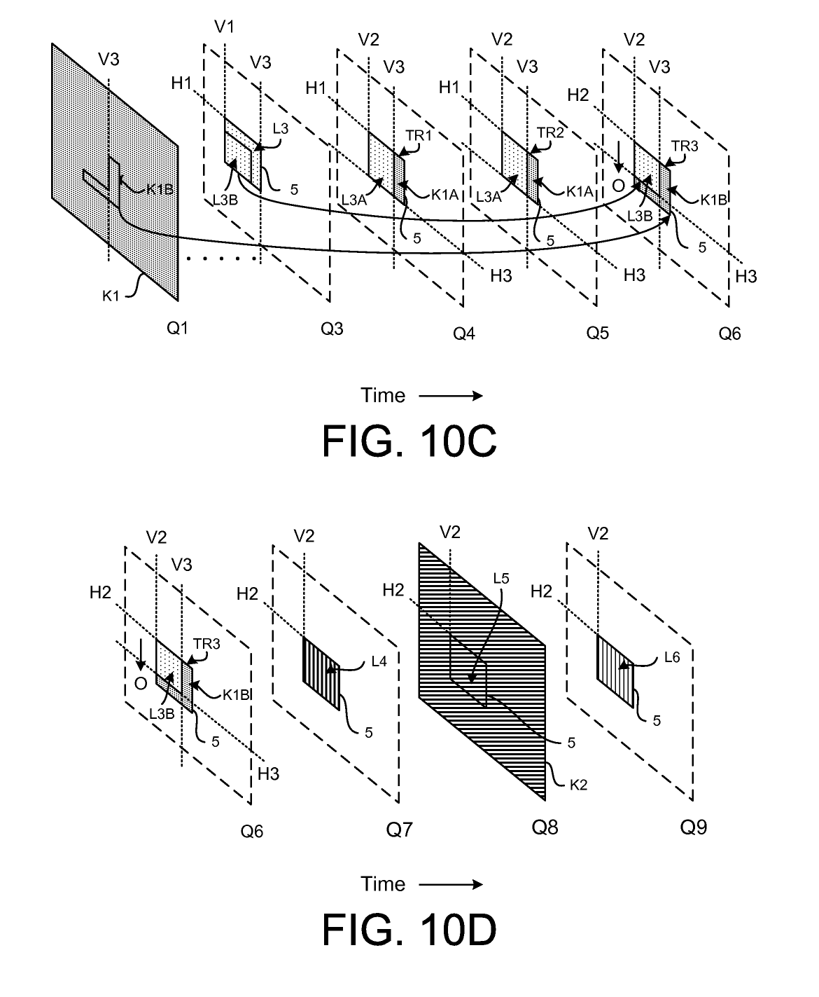

FIGS. 10A through 10D are diagrams that illustrate transition images produced based on copied host images, according to an embodiment. The images shown in FIGS. 10A through 10D are processed at a client device. The image processing associated with the images illustrated in FIGS. 10A through 10D can be performed after a client-host session is established between a host device and the client device.

As shown in FIG. 10A, a copied host image K1 is received at time Q1 and stored at the client device. The copied host image K1 can be a copy of a host image produced at the host device in response to processing performed by an application.

At time Q1, a portion of the copied host image K1 is displayed at the client device as client image L1 based on a target display area 5 at target coordinates (H1, V1). As shown in FIG. 10A, the client image L1 has a right edge aligned along a vertical line V3.

At time Q2, a client image L2 is received at the client device and is displayed at the client device based on the target display area 5 at target coordinates (H1,V1). The client image L2 can be an update to client image L1 at the target coordinates (H1,V1). The client image L2 can be based on a host image that is an update to the host image copied as host image K1. As shown in FIG. 10A, the client image L2 has a right edge aligned along the vertical line V3.

At time Q3, a client image L3 is received at the client device and is displayed at the client device based on the target display area 5 at target coordinates (H1,V1). The client image L3 can be an update to client image L2 at the target coordinates (H1,V1). The client image L3 can be based on a host image that is an update to the host image used to produce client image L2. As shown in FIG. 10A, the client image L3 has a right edge aligned along the vertical line V3.

As shown in FIG. 10B, at time Q4, the target display area 5 is shifted to the right along direction N from the target coordinates (H1,V1) to the target coordinates (H1,V2). With the shift of the target display 5 to the right along direction N, a portion of the target display area 5 crosses over the vertical line V3. Accordingly, at time Q4 a transition image TR1 is defined using a portion L3A of the client image L3 and a portion K1A of the copied host image K1. In some embodiments, a time period during which the transition image TR1 is triggered for display can be referred to as a transition time period.

Because the transition image TR1 may include some portions that are not synchronized with current images (e.g., host images) produced at the host device, one or more input values from one or more input devices interacting with the transition image TR1 may not be registered (e.g., may be ignored, may be discarded). In other words, interactions (represented by input values) triggered by input devices can be disabled (e.g., temporarily disabled) with respect to the transition image TR1 (e.g., during a transition time period). In some embodiments, interactions with the only some portions (e.g., portion K1A and/or portion L1) of the transition image TR1 may be not be registered because they can be associated with the host copied image K1, which can be considered as being outdated and may not be synchronized with a current state of processing of the host device.

As shown in FIG. 10C, at times Q5, the target display area 5 is at the target coordinates (H1,V2) (which is the same position as at time Q4 shown in FIG. 10B). At time Q5, transition images TR2, respectively, are defined using the portion L3A of the client image L3 and the portion K1A of the copied host image K1. In some embodiments, multiple consecutive transitions images, such as transitions images TR1 and TR2, can be defined at the client device when an updated client image has not yet been received from the host device. Accordingly, in some embodiments, multiple consecutive transition images can be defined based on combinations of a copied host image and a current or prior client image. If an updated client image had been received from the host device in response to the movement of the target display area 5, one or more of the transitions images TR1 and TR2 may not have been defined at the client device.

As shown in FIG. 10C, at time Q6, the target display area 5 is shifted in a downward direction along direction O from the target coordinates (H1,V2) to the target coordinates (H2,V2). With the shift of the target display area 5 to downward along direction O, a portion of the target display area 5 crosses over the horizontal line H3. Accordingly, at time Q6 a transition image TR3 is defined using a portion L3B of the client image L3 and a portion K1B of the copied host image K1. Portion L3B of the client image L3 includes portions of the portion L3A of the client image L3. In other words, portion L3A and portion L3B have overlapping portions. Also, portion K1B of the copied host image K1 includes portions of the portion K1A of the copied host image K1. In other words, portion K1B and portion K1A have overlapping portions.

As shown in FIG. 10D, at time Q7, the transition image TR3, which is a combination of the portion K1B of the copied host image K1 and the portion L3B of the client image L3 (originally received that time Q3), is replaced by client image L4. The client image L4 corresponds with the target display area 5 at the target coordinates (H2,V2). Client image L4 can be a portion of a host image (e.g., a new host image) from a host device that corresponds with the target display area 5 at target coordinates (H2, V2). In some embodiments, a time period during which the transition images TR1 through TR3 are triggered for display can be referred to as a transition time period.

Also as shown in FIG. 10D, a copied host image K2 is received at the client device from the host device, and the client image L5 is displayed at the client device. The client image L5 corresponds with the target display area 5 at the target coordinates (H2,V2) of the copied host image K2. The copied host image K2 can be cached at the client device for use in defining one or more transition images (if needed). In some embodiments, the copied host image K1 can be discarded in response to the copied host image K2 being received. In some embodiments, one or more copied host images (e.g., copied host image K1, copied host image K2) can be produced at the host device and sent to the client device, for example, periodically, randomly, based on a schedule, in response to a threshold number or magnitude of movements of a target display area, in response to a request from the client device, after a threshold period of time has passed, based on a specified number of frames being sent to the client device, in response to a relatively significant change in the operating environment (e.g., a number of pixels or opening of a new window) of an application at the host device, and/or so forth.

Finally, as shown in FIG. 10D, the client image L6, which corresponds with the target display area 5 at the target coordinates (H2,V2), is received at the client device and displayed at the client device. In this embodiment, a transition image is not created based on the host copied image K2 because the client image L6 is received in a timely fashion before creation of the transition images triggered.

As shown in FIG. 10D, at time Q7, the transition image TR3, which is a combination of the portion K1B of the copied host image K1 and the portion L3B of the client image L3 (originally received that time Q3), is replaced by client image L4 (which can be a portion of a host image (e.g., a new host image) from a host device that corresponds with the target display area 5 at target coordinates (H2, V2)). The client image L4 corresponds with the target display area 5 at the target coordinates (H2,V2).

Because the transition images TR1 through TR3 may include some portions that are not synchronized with current images (e.g., host images) produced at the host device, one or more input values from one or more input devices interacting with one or more of the transition images TR1 through TR3 (or a portion thereof) may not be registered (e.g., may be ignored, may be discarded). In some embodiments, one or more input values from one or more input devices interacting with only a portion of one or more of the transition images TR1 through TR3 such as portion K1A, may not be registered, while one or more input values from one or more input devices interacting with L3A may be registered. In other words, interactions (represented by input values) triggered by input devices can be disabled (e.g., temporarily disabled) with respect to one or more of the transition image TR1 through TR3 (e.g., or outdated portions thereof, during a transition time period). In some embodiments, after transition image TR3 is replaced by client image L4, one or more input values from one or more input devices interacting with the client image L4 can be registered. In other words, interactions triggered by input devices (or registering of interactions) can be enabled (e.g., changed from disabled state). Similarly, interactions triggered by input devices (or registering of interactions) with respect to client images L5 and L6 can also be registered because of these client images are not transition images.

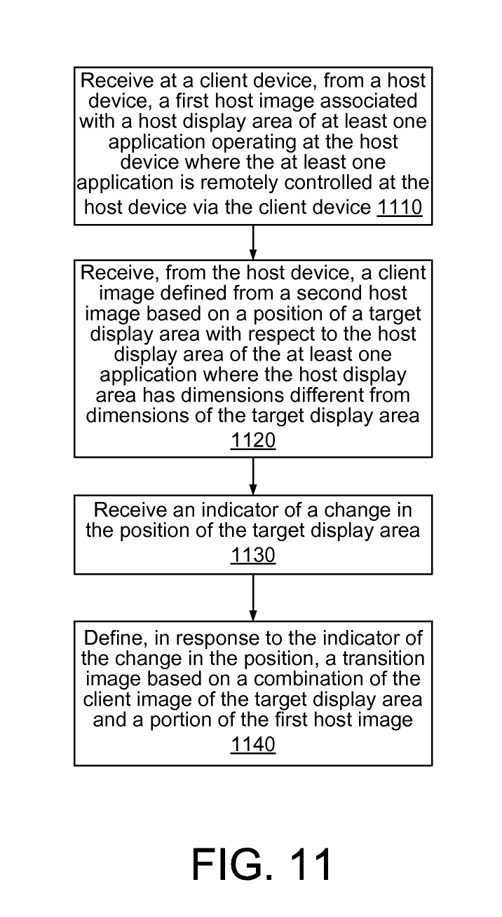

FIG. 11 is a flowchart that illustrates a method related to processing transition images, according to embodiment. At least some portions of the flowchart can be performed by a client device and/or a host device such as those shown in FIG. 2.

A first host image associated with a host display area of at least one application operating at the host device is received at a client device from a host device where the at least one application is remotely controlled at the host device via the client device (block 1110). In some embodiments, the first host image can be received at the host image processor 278 of the client device 200 shown in FIG. 2. In some embodiments, the first host image can be produced in response to an interaction with the at least one application operating at the host device. In some embodiments, the host device can be remotely controlled by the client devices via, for example, a remote desktop session. In some embodiments, the first host image can be associated with a stream of images.

A client image defined from a second host image based on a position of a target display area with respect to the host display area of the at least one application is received from the host device where the host display area has dimensions different from dimensions of the target display area (block 1120). In some embodiments, the client image can be received by the client image processor 277 of the client device 200 shown in FIG. 2. In some embodiments, the client image can be produced by the client image generator 284 of the host device 250 shown in FIG. 2. In some embodiments, the position of the target display area can be defined based on a default position exchanged between the client device and the host device during establishment of a client post session. In some embodiments, the position can be defined in response to the user triggered interaction via an input device associated with the client device.

An indicator of a change in the position of the target display area is received (block 1130). In some embodiments, the indicator of the change in the position can be triggered by an input value produced by the input device 242 shown in FIG. 2. In some embodiments, the change in the position can be with respect to an origin associated with the host display area.

A transition image is defined in response to the indicator of the change in the position based on a combination of the client image of the target display area and a portion of the first host image (block 1140). In some embodiments, the transition image can be defined by the transition image module 279 of the client device 200 shown in FIG. 2. In some embodiments, multiple transition images can be defined until a new host image is received or until an updated client images received from the host device. In some embodiments, one or more input values produced by an input device can be discarded while the transition image is being triggered for display at the client device. Registering of one or more input values produced by the input device can be enabled after the transition images are triggered for display at the client device during a transition image time period. In other words, registering of one or more input values produced by the input device can be enabled after the transition image time period has been completed.

In some embodiments, the transition image, which can be triggered for display as a client image, can have an aspect ratio different than an aspect ratio of the first host image received at the client device (such as the aspect ratios shown, for example, in connection with FIGS. 6A through 6E). In some embodiments, the transition image can be defined based on initialization parameter values (e.g., offset boundary values, dimension values, default initial position values, offset values) exchanged during establishment of client host session such as those described in connection with, for example, FIGS. 4 through 9. Accordingly, in some embodiments, the target display area and/or the transition image can include at least some portions of an area (e.g., a background image) outside of the first host image received at the client device. More details related to transition images are described below.

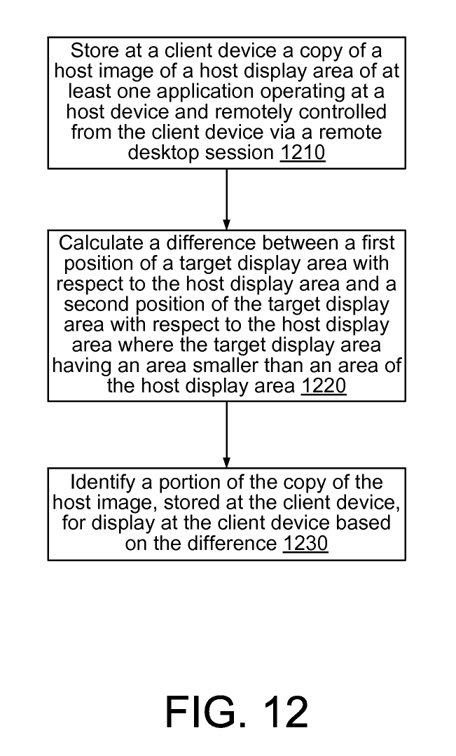

FIG. 12 is a flowchart that illustrates another method related to processing of transition images, according to embodiment. At least some portions of the flowchart can be performed by a client device and/or a host device such as those shown in FIG. 2.

A copy of a host image of a host display area of an application operating at a host device is stored at a client device where the application is remotely controlled from the client device via a remote desktop session (block 1210). In some embodiments, the copy of the host image can be received by the host image processor 278 of the client device 200 shown in FIG. 2.

A difference between a first position of a target display area with respect to the host display area and a second position of the target display area with respect to the host display area is calculated where the target display area has an area smaller than an area of the host display area (block 1220). In some embodiments, the difference between a first position and the difference between the second position can be calculated by the client target movement module 235 of the client device 200 shown in FIG. 2. In some embodiments, the change from the first position to the second position can be triggered via an input value produced by the input device 242 shown in FIG. 2. In some embodiments, a shape of the target display area can be different than a shape of the host display area. In some embodiments, an aspect ratio of the target display area can be different than an aspect ratio of the host display area.

A portion of the copy of the host image, stored at the client device, can be identified for display at the client device based on the difference (block 1230). In some embodiments, the portion of the copy of the host image can be identified by the transition image module 279 of the client device 200 shown in FIG. 2. In some embodiments, at least a portion of a transition image can be defined based on the portion of the copy of the host image. In some embodiments, the transition image, which can be triggered for display as a client image, can have an aspect ratio different than an aspect ratio of the copy of the host image (such as the aspect ratios shown, for example, in connection with FIGS. 6A through 6E). In some embodiments, the transition image can be defined based on initialization parameter values (e.g., offset boundary values, dimension values, default initial position values, offset values) exchanged during establishment of client host session such as those described in connection with, for example, FIGS. 4 through 9. Accordingly, in some embodiments, the transition image can include at least some portions of an area (e.g., a background image) outside of the copy of the host image. More details related to transition images are described below.

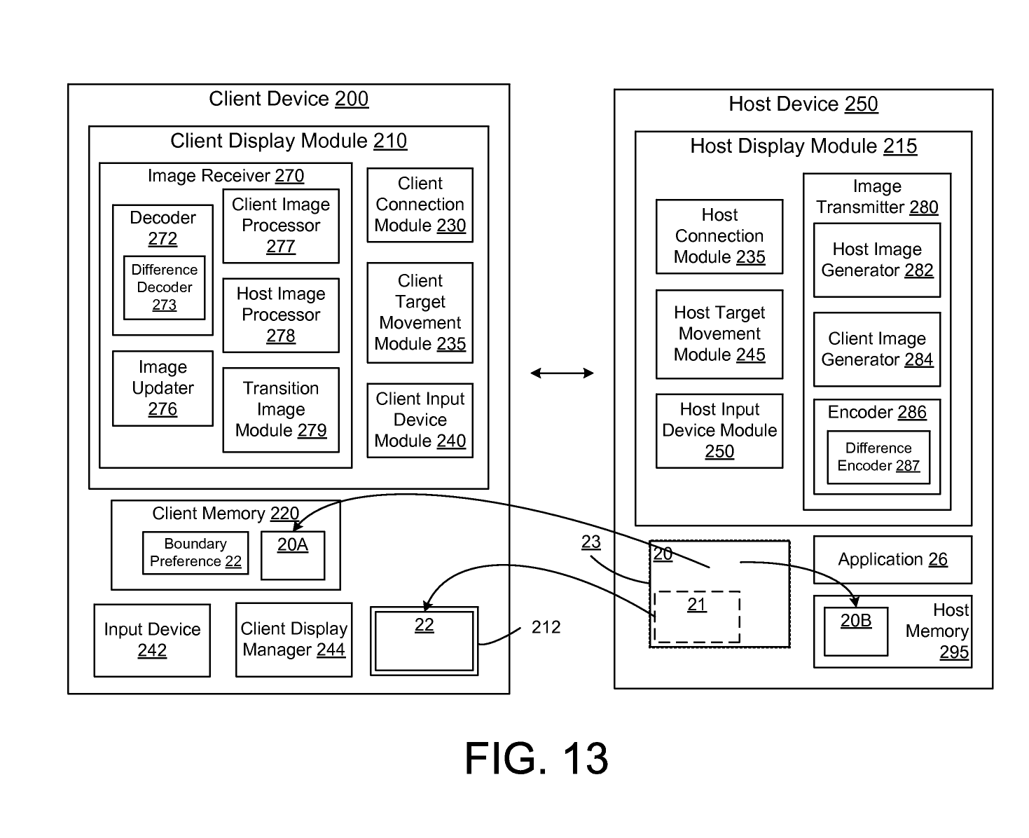

FIG. 13 is a diagram that illustrates the client device 200 and the host device 250 shown in FIG. 2 modified to process mirrored host images. Specifically, the client memory 220 is configured to store a copy of the host image 20, which can be referred to as mirrored host image 20A, and the host memory 295 is configured to store a copy of the host image 20, which can be referred to as mirrored host image 20B. In some embodiments, the mirrored host image 20A and/or the mirrored host image 20B can be non-encoded (e.g., uncompressed) or encoded (e.g., compressed) images.

The mirrored host image 20A and mirrored host image 20B can be referred to as mirrored because changes to the mirrored host image 20A can be mirrored in the mirrored host image 20B, and vice versa. Accordingly, the mirrored host image 20A can be a duplicate of the mirrored host image 20B even with changes to either of the mirrored host images 20A, 20B. In other words, the mirrored host image 20A and mirrored host image 20B can be synchronized with one another by continually mirroring updates to either of the host images 20A, 20B.

The mirrored host image 20A is stored (e.g., cached, temporarily stored) in the client memory 220 and the mirrored host image 20B is stored (e.g., cached, temporarily stored) in the host memory 295 so that updated client images can be processed in an efficient fashion (e.g., bandwidth efficient fashion, low bandwidth fashion, relatively low bitrate fashion). Specifically, the encoder 286 includes a difference encoder 287 configured to identify one or more differences (e.g., incremental changes) between an updated client image produced at the host device 250 and the mirrored host image 20B (stored at the host device 250). Rather than sending the entire updated client image (or a portion thereof), one or more indicator(s) of the difference(s) between the updated client image and the mirrored host image 20B can be sent to the client device 200. The decoder 272 of the client device 200 includes a difference decoder 287 configured to decode the one or more indicators of the difference(s) with reference to the mirrored host image 20A (stored at client device 200) to reproduce the updated client image at the client device 200. Accordingly, the updated client image produced at the host device 250 can be reproduced at the client device 200 in an efficient fashion by sending one or more indicators of differences between the updated client image and the mirrored host images 20A, 20B.

In some embodiments, one or more indicators of one or more differences can be included in, for example, one or more packets, one or more instructions, and/or so forth. In some embodiments, one or more indicators of one or more differences can include motion vectors, motion estimation information, compressed portions, and/or so forth.

In some embodiments, the indicators of the differences (e.g., incremental changes) from the updated client image can be used to update the mirrored host image 20A and the mirrored host image 20B. Accordingly, the mirrored host image 20A and the mirrored host image 20B can be synchronized (e.g., mirrored). For example, the difference encoder 287 can be configured to identify a difference between an updated client image produced at the host device 250 and the mirrored host image 20B (stored at the host device 250). An indicator of the difference can be used to update the mirrored host image 20B at the host device 250 and the indicator of the difference can also be sent from the host device 250 to the client device 200. The difference decoder 287 can be configured to decode the indicator of the difference with reference to the mirrored host image 20A (stored at client device 200) to reproduce the updated client image at the client device 200. Also, the indicator of the difference can be used to update the mirrored host image 20A. Accordingly, the updated client image produced at the host device 250 can be reproduced at the client device 200 and the mirrored host images 20A, 20B can be maintained in a synchronized state (e.g., mirrored state). In some embodiments, because the mirrored host image 20A and the mirrored host image 20B are used as references from which encoding and decoding of differences can be performed (e.g., performed to produce client images), the mirrored host images 20A, 20B can be referred to as reference host images.

In some embodiments, differences (e.g., deltas) that can be used to produce an updated client image at the host device 250 and reproduce the updated client image at the client device 200 can be triggered in response to movement of the target display area 21. For example, the client image 22, which is displayed at the display 212 of the client device 200, can be produced based on the target display area 21 within the host display area 23 (illustrated by dashed line) of the host image 20. In response to an indicator of movement of the target display area 21 within the host display area 23 from a first position to a second position, the client image generator 284 can be configured to produce an updated client image (or portion thereof) to the client image 22 based on the host image 20. An indicator of a difference between the updated client image and the mirrored host image 20B can be used to update the mirrored host image 20B in an area corresponding with the target display area 21 at the second position. The indicator of the difference can be used at the client device 200 to reproduce the updated client image and update the mirrored host image 20A in an area corresponding with the target display area 21 at the second position. Accordingly, the updated client image produced at the host device 250 can be reproduced at the client device 200 and the mirrored host images 20A, 20B can be maintained in a synchronized state (e.g., mirrored state) in response to movement of the target display area 21.

In some embodiments, one or more transition images can be used in conjunction with the indicators of differences described above. For example, in response to movement of a target display area a transition image can be defined and triggered for display as a first client image. After the transition image has been defined, a second client image can be defined and triggered for display based on an indicator of a difference from a mirrored host image. In other words, the techniques described in connection with, for example, FIGS. 10A through 12 can be used in conjunction with processing of (e.g., generation of, production of) client images related to mirrored host images. As another example, in response to movement of a target display area, a first client image can be defined and triggered for display based on an indicator of a difference from a mirrored host image. After the first client image has been triggered for display, a transition image can be defined and triggered for display as a second client image based on the mirrored host image (which can be updated based on the indicator of the difference).

In some embodiments, a client image defined based on one or more mirrored host images, can have an aspect ratio different than an aspect ratio of the mirrored host image(s) (and/or the host image 20) (such as the aspect ratios shown, for example, in connection with FIGS. 6A through 6E). In some embodiments, the client image, which can be defined based on one or more mirrored host images, can also be defined based on initialization parameter values (e.g., offset boundary values, dimension values, default initial position values, offset values) exchanged during establishment of client host session such as those described in connection with, for example, FIGS. 4 through 9. Accordingly, in some embodiments, the target display area and/or the client image, which can be defined based on one or more mirrored host images, can include at least some portions of an area (e.g., a background image) outside of the mirrored host image(s) (and/or the host image 20).

The components (e.g., modules, processors) of the client device 200 and/or the components (e.g., modules, processors) of the host device 250 can be configured to operate based on one or more platforms (e.g., one or more similar or different platforms) that can include one or more types of hardware, software, firmware, operating systems, runtime libraries, and/or so forth. In some implementations, the components of the client device 200 and/or the components of the host device 250 can be configured to operate within a cluster of devices (e.g., a server farm). In such an implementation, the functionality and processing of the components of the client device 200 and/or the components of the host device 250 can be distributed to several devices of the cluster of devices.

The components of the client device 200 and/or the components of the host device 250 can be, or can include, any type of hardware and/or software configured to process attributes. In some implementations, one or more portions of the components shown in the components of the client device 200 and/or the components of the host device 250 in FIG. 13 (and/or FIG. 2) can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the client device 200 and/or the components of the host device 250 can be, or can include, a software module configured for execution by at least one processor (not shown). In some implementations, the functionality of the components can be included in different modules and/or different components than those shown in FIG. 13 (and/or FIG. 2).

In some embodiments, one or more of the components of the client device 200 and/or the components of the host device 250 can be, or can include, processors configured to process instructions stored in a memory. For example, the image transmitter 280 (and/or a portion thereof) and/or the image receiver 270 (and/or a portion thereof) can be a combination of a processor and a memory configured to execute instructions related to a process to implement one or more functions.

Although not shown, in some implementations, the components of the client device 200 and/or the components of the host device 250 (or portions thereof) can be configured to operate within, for example, a data center (e.g., a cloud computing environment), a computer system, one or more server/host devices, and/or so forth. In some implementations, the components of the client device 200 and/or the components of the host device 250 (or portions thereof) can be configured to operate within a network. Thus, the components of the client device 200 and/or the components of the host device 250 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, the client memory 220 and/or the host memory 295 can be any type of memory such as a random-access memory, a disk drive memory, flash memory, and/or so forth. In some implementations, the client memory 220 and/or the host memory 295 can be implemented as more than one memory component (e.g., more than one RAM component or disk drive memory) associated with the components of the client device 200 and/or the components of the host device 250. In some implementations, the client memory 220 and/or the host memory 295 can be a database memory. In some implementations, the client memory 220 and/or the host memory 295 can be, or can include, a non-local memory. For example, the client memory 220 and/or the host memory 295 can be, or can include, a memory shared by multiple devices (not shown). In some implementations, the client memory 220 and/or the host memory 295 can be associated with a server device (not shown) within a network and configured to serve the components of the client device 200 and/or the components of the host device 250.

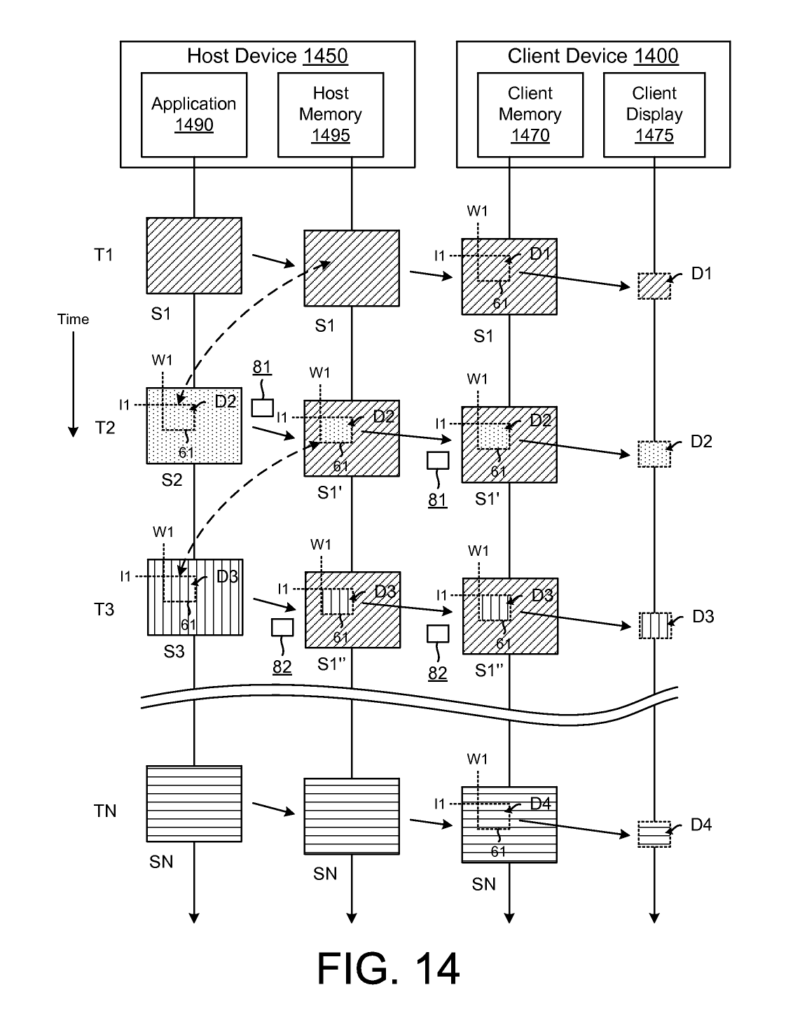

FIG. 14 is a timing diagram that illustrates processing based on mirrored host images, according to an embodiment. Specifically, the timing diagram illustrates an application 1490 and a host memory 1495 included in a host device 1450, and a client memory 1470 and a client display 1475 included in a client device 1400. At least some processing modules (e.g., image processing modules) included in the host device 1450 and/or in the client device 1400, such as the difference encoder 287 and the difference decoder 273 shown in FIG. 13, are not shown in this timing diagram. As shown in FIG. 14, time is increasing in a downward direction.

As shown in FIG. 14, a series of host images S1 through SN are produced by an application 1490 operating a host device 1450, respectively, at approximately times T1 through TN. One or more of the host images S1 through SN can be produced in response to one or more operations triggered by the application 1490, in response to interactions of a user with the application 1490 at the host device 1450 via the client device 1400 through a client-host session (e.g., a remote desktop session), and/or so forth. In some embodiments, one or more of the images (or portions thereof) shown in FIG. 14 (e.g., host images S1 through SN, client images, indicators of differences) can be encoded and/or decoded at the host device 250 and/or at the client device 200 shown in FIG. 13.

As shown in FIG. 14, the host image S1 is produced by an application 1490 at approximately time T1. The host image S1 (e.g., a copy of the host image S1) is stored (e.g., cached) as a mirrored host image (which can be encoded) in the host memory 1495, and is sent to the client device 1400 for storage (e.g., caching) in the client memory 1470 as a mirrored host image (which can be encoded). Based on a position of a target display area 61 within the host image S1 (and/or with respect to a host display area) at target coordinates (W1,I1) a portion D1 of the host image S1 (stored at the client memory 1470) is triggered for display (after being decoded) within the client display 1475 as a client image.

At approximately time T2, the host image S2 is produced by the application 1490. A portion D2 of the host image S2 corresponding with the target display area 61 at target coordinates (W1, I1) is compared (as illustrated by the dashed double-sided arrow) with the host image S1 stored in the host memory 1495 to identify differences (e.g., deltas, incremental changes) (if any) between the portion D2 of the host image S2 and the host image S1. In some embodiments, the portion D2 of the host image S2 corresponding with the target display area 61 at target coordinates (W1, I1) is compared with an area of the host image S1 corresponding with the target display area 61 at target coordinates (W1, I1). The differences can be encoded (e.g., encoded by the difference encoder 287 shown in FIG. 13) as encoded differences 81 (or indicators thereof), and can be used (e.g., used by a difference decoder) to modify the host image S1 stored in the host memory 1495 to host image S1′. In such embodiments, the host image S1 (or portion thereof) can be a reference image to calculate the encoded difference 81. Accordingly, the host image S1′ will be a combination of the host image S1 and the host image S2. In some embodiments, another area of host image S1, outside of, or in addition to, the area corresponding with target coordinates (W1,I1) can be used as a reference to calculate the encoded differences 81 (to achieve a relatively low bit rate).

The encoded differences 81 are sent from the host device 1450 to the client device 1400 where the encoded differences 81 can be used (e.g., used by (e.g., decoded by) the difference decoder 273 shown in FIG. 13) to modify the host image S1 stored in the client memory 1470 to host image S1′, which mirrors the host image S1′ stored in the host memory 1495. Based on a position of the target display area 61 within the host image S1′ at target coordinates (W1,I1) the portion D2 of the host image S1′ (stored at the client memory 1470) is triggered for display within the client display 1475 as a client image.

At approximately time T3, the host image S3 is produced by the application 1490. A portion D3 of the host image S3 corresponding with the target display area 61 at target coordinates (W1, I1) is compared (as illustrated by the dashed double-sided arrow) with the host image S1′ stored in the host memory 1495 to identify differences (if any) between the portion D3 of the host image S3 and the host image S1′. The differences can be encoded (e.g., encoded by the difference encoder 287 shown in FIG. 13) as encoded differences 82 (or indicators thereof), and can be used to modify the host image S1′ stored in the host memory 1495 to host image S1″. Accordingly, the host image S1″ will be a combination of the host image S1′ and the host image S3, or can be equivalent to a combination of the host image S1 and the host image S3.

The encoded differences 82 are sent from the host device 1450 to the client device 1400 where the encoded differences 82 can be used (e.g., used by (e.g., decoded by) the difference decoder 273 shown in FIG. 13) to modify the host image S1′ stored in the client memory 1470 to host image S1″, which mirrors the host image S1″ stored in the host memory 1495. Based on a position of the target display area 61 within the host image S1″ at target coordinates (W1,I1) the portion D3 of the host image S1″ (stored at the client memory 1470) is triggered for display within the client display 1475 as a client image. In some embodiments, the encoded differences 81 and/or the encoded differences 82 can be based on an area larger than the target display area 61.

As shown in FIG. 14, the host image SN is produced by the application 1490 at approximately time TN. The host image SN (e.g., a copy of the host image SN) (which can be encoded) is stored as a mirrored host image in the host memory 1495 and replaces a prior mirrored host image (e.g., host image S1″) stored in the host memory 1495. The host image SN is also sent to the client device 1400 for storage in the client memory 1470 as a mirrored host image (which can be encoded) and replaces a prior mirrored host image (e.g., host image S1″) stored in the client memory 1470. Based on a position of a target display area 61 within the host image SN (and/or with respect to a host display area) at target coordinates (W1,I1) a portion D4 of the host image SN (stored at the client memory 1470) is triggered for display (after being decoded) within the client display 1475 as a client image. In some embodiments, one or more transition images can be defined and triggered for display as a client image within the timeline described above (e.g., after time T3 and before time TN, before time T1) based on one or more mirrored images stored at the client memory 1470 and one or more client images triggered for display at the client display 1475.

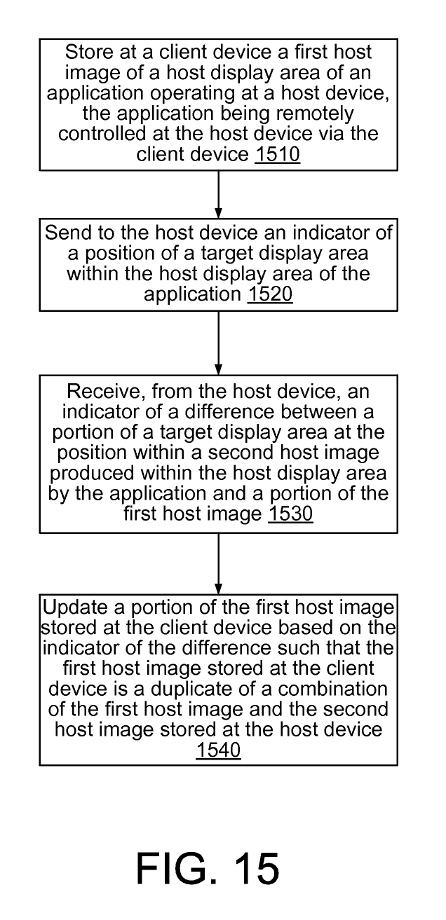

FIG. 15 is a flowchart that illustrates a method for processing mirrored images, according to embodiment. At least some portions of the flowchart can be performed by a client device and/or a host device such as those shown in FIG. 2 and FIG. 13.

A first host image of a host display area of an application operating at a host device is stored at a client device where the application is remotely controlled at the host device via the client device (block 1510). The first host image can be produced by the host image generator 282 of the host device 250 and can be received by the host image processor 278 of the client device 200 shown in FIG. 13. In some embodiments, the application can be remotely controlled at the host device via a client-host session (e.g., a remote desktop session). In some embodiments, the first host image can be a full scope image of an operating environment (including one or more user interfaces of the application) of the host device.

An indicator of a position of a target display area within the host display area of the application is sent to the host device (block 1520). In some embodiments, the indicator of the position of the target display area can be sent to the host device by the client target movement module 235 shown in FIG. 13. In some embodiments, the position of the target display area can be a default position of the target display area defined during establishment of a client-host session, can be an indicator of the position of the target display area produced in response to an input device, can be an indicator of movement of the position of the target display area, and/or so forth.

An indicator of a difference between a portion of a target display area at the position within a second host image produced within the host display area by the application and a portion of the first host image is received from the host device (block 1530). The indicator of the difference between the portion of the target display area and the portion of the first host image can be produced by the difference encoder 287 of the host device 250 shown in FIG. 13.

A portion of the first host image (e.g., less than all of the first host image) stored at the client device is updated based on the indicator of the difference such that the first host image stored at the client device is a duplicate of a combination of the first host image and the second host image stored at the host device (block 1540). In some embodiments, the first host image stored at the client device can be updated by the difference decoder 273 of the client device 200 shown in FIG. 13. In some embodiments, the combination of the first host image and the second host image stored of the host device can be defined by updating the first host image stored at the host device based on the indicator of the difference.

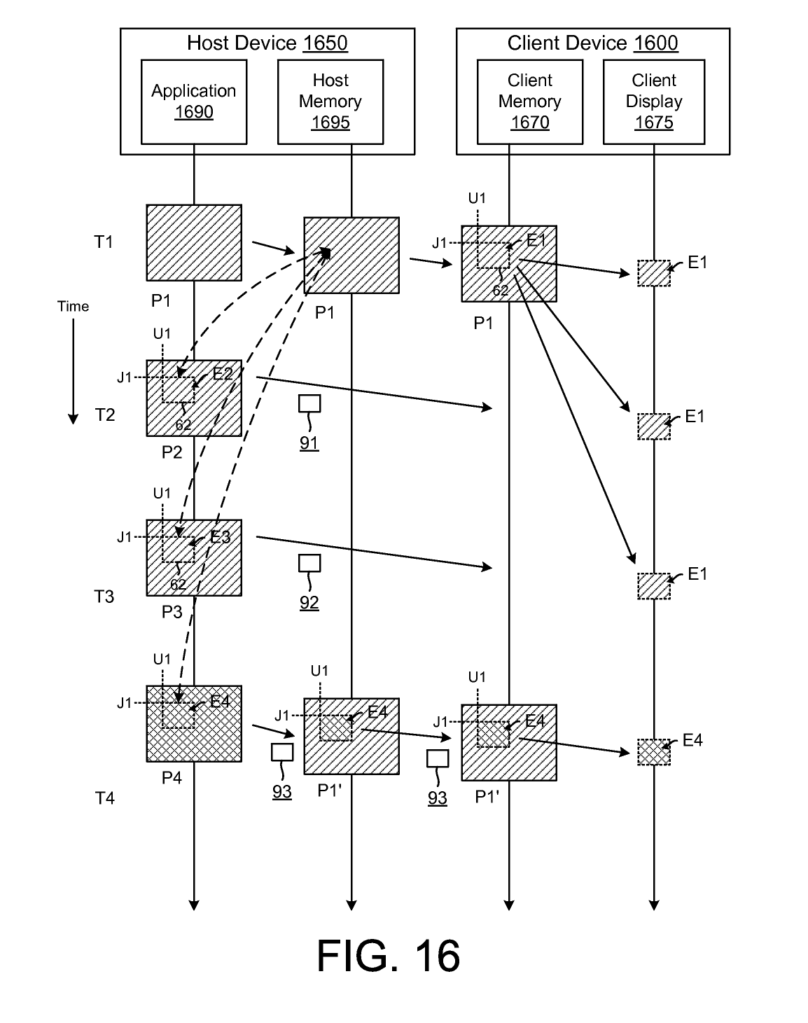

FIG. 16 is a timing diagram that illustrates triggering of display of client images based on a mirrored host image, according to an embodiment. Specifically, the timing diagram illustrates an application 1690 and a host memory 1695 included in a host device 1650, and a client memory 1670 and a client display 1675 included in a client device 1600. At least some processing modules (e.g., image processing modules) included in the host device 1650 and/or in the client device 1600, such as the difference encoder 287 and the difference decoder 273 shown in FIG. 13, are not shown in this timing diagram. As shown in FIG. 16, time is increasing in a downward direction.

As shown in FIG. 16, a series of host images P1 through P4 are produced by an application 1690 operating a host device 1650, respectively, at approximately times T1 through TN. One or more of the host images P1 through P4 can be produced in response to one or more operations triggered by the application 1690, in response to interactions of a user with the application 1690 at the host device 1650 via the client device 1600 through a client-host session (e.g., a remote desktop session), and/or so forth. In some embodiments, one or more of the images (or portions thereof) shown in FIG. 16 (e.g., host images P1 through P4, client images, indicators of differences (e.g., deltas)) can be encoded and/or decoded at the host device 250 and/or at the client device 200 shown in FIG. 13.

As shown in FIG. 16, the host image P1 is produced by an application 1690 at approximately time T1. The host image P1 (e.g., a copy of the host image P1) is stored (e.g., cached) as a mirrored host image (which can be encoded) in the host memory 1695, and is sent to the client device 1600 for storage (e.g., caching) in the client memory 1670 as a mirrored host image (which can be encoded). Based on a position of a target display area 62 within the host image P1 (and/or with respect to a host display area) at target coordinates (U1,J1) a portion E1 of the host image P1 (stored at the client memory 1670) is triggered for display (after being decoded) within the client display 1675 as a client image.

At approximately time T2, the host image P2 is produced by the application 1690, which is identical to the host image P1. A portion E2 of the host image P2 corresponding with the target display area 62 at target coordinates (U1, J1) is compared (as illustrated by the dashed double-sided arrow) with the host image P1 stored in the host memory 1695 to identify differences (if any) between the portion E2 of the host image P2 and the host image P1. In some embodiments, the portion E2 of the host image P2 corresponding with the target display area 62 at target coordinates (U1,J1) is compared with an area of the host image P1 corresponding with the target display area 62 at target coordinates (U1,J1) (or another portion of the host image P1).

In this embodiment, because the host image P1 is identical to the host image P2, an indicator 91 (which can be produced by the difference encoder 287 shown in FIG. 13) sent from the host device 1650 to the client device 1600 indicates no differences (e.g., no deltas) between the portion E2 of the host image P2 and the host image P1. In such embodiments, the host image P1 stored at the host memory 1695 may not be updated at all, or may be updated (e.g., updated by a difference decoder of the host device 250) with no differences. Similarly, the host image P1 stored at the client memory 1670 may not be updated at all, or may be updated (e.g., updated by the difference decoder 273 shown in FIG. 13) with no differences. Based on the position of the target display area 62 within the host image P1 at target coordinates (U1,J1) the portion E1 of the host image P1 (stored at the client memory 1670) is again triggered for display within the client display 1675 as a client image.

Because the several copies of client images E1 associated with times T2 through T3 are identified as being associated with host images P2 and P3, which are identical to host image P1, one or more input values from one or more input devices associated with the client images E1 are registered. In other words, one or more input values from one or more input devices are not discarded, and registering of the input value(s) is not disabled (e.g., remains enabled). For example, the client image E1 (triggered for display at the client display 1675) associated with the host image P2 includes valid information with which a user may interact because the host image P2 is identical to the host image P1. Similarly, the client image E1 associated with the host image P3 includes valid information with which a user may interact because the host image P3 is identical to the host image P1.

At approximately time T3, the host image P3 is produced by the application 1690, which is identical to the host image P2. A portion E3 of the host image P3 corresponding with the target display area 62 at target coordinates (U1, J1) is compared (as illustrated by the dashed double-sided arrow) with the host image P1 stored in the host memory 1695 to identify differences (if any) between the portion E3 of the host image P3 and the host image P1. In this embodiment, because the host image P1 is identical to the host image P3, an indicator 92 (which can be produced by the difference encoder 287 shown in FIG. 13) sent from the host device 1650 to the client device 1600 indicates no differences between the portion E3 of the host image P3 and the host image P1. In such embodiments, the host image P1 stored at the host memory 1695 may not be updated at all, or may be updated (e.g., updated by a difference decoder of the host device 250) with no differences. Similarly, the host image P1 stored at the client memory 1670 may not be updated at all, or may be updated (e.g., updated by the difference decoder 273 shown in FIG. 13) with no differences. Based on the position of the target display area 62 within the host image P1 at target coordinates (U1,J1) the portion E1 of the host image P1 (stored at the client memory 1670) is again triggered for display within the client display 1675 as a client image.

At approximately time T4, the host image P4 is produced by the application 1690. The host image P4 is different than (e.g., is updated relative to) the host images P1 through P3. A portion E4 of the host image P4 corresponding with the target display area 62 at target coordinates (U1, J1) is compared (as illustrated by the dashed double-sided arrow) with the host image P1 stored in the host memory 1695 to identify differences (if any) between the portion E4 of the host image P4 and the host image P1. The differences can be encoded (e.g., encoded by the difference encoder 287 shown in FIG. 13) as encoded differences 93 (or indicators thereof), and can be used (e.g., used by a difference decoder of the host device 250) to modify the host image P1 stored in the host memory 1695 to host image P1′. Accordingly, the host image P1′ will be a combination of the host image P1 and the host image P4.

The encoded differences 93 are sent from the host device 1650 to the client device 1600 where the encoded differences 93 can be used (e.g., used by (e.g., decoded by) the difference decoder 273 shown in FIG. 13) to modify the host image P1 stored in the client memory 1670 to host image P1′, which mirrors the host image P1′ stored in the host memory 1695. Based on a position of the target display area 62 within the host image P1′ at target coordinates (U1,J1) the portion E4 of the host image P1′ (stored at the client memory 1670) is triggered for display within the client display 1675 as a client image. In some embodiments, one or more transition images can be defined and triggered for display as a client image in conjunction with the timeline described above (e.g., after time T4, before time T1) based on one or more mirrored images stored at the client memory 1670 and one or more client images triggered for display at the client display 1675.

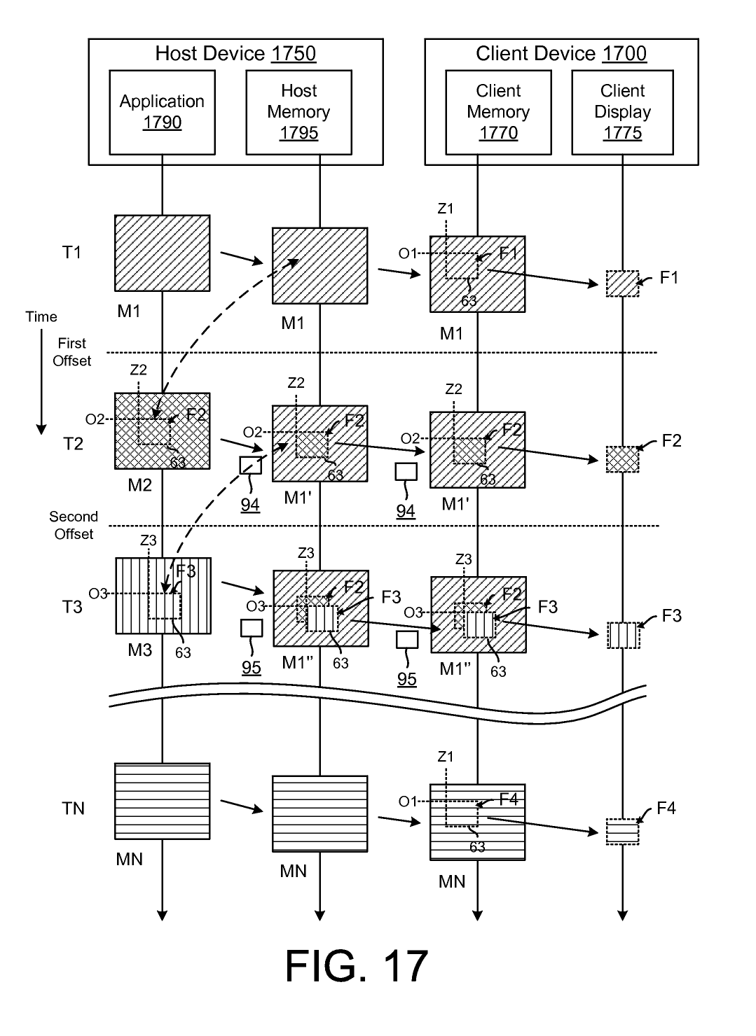

FIG. 17 is a timing diagram that illustrates processing of client images based on mirrored host images in response to changes in a location of a target display area 63, according to an embodiment. Specifically, the timing diagram illustrates an application 1790 and a host memory 1795 included in a host device 1750, and a client memory 1770 and a client display 1775 included in a client device 1700. At least some processing modules (e.g., image processing modules) included in the host device 1750 and/or in the client device 1700, such as the difference encoder 287 and the difference decoder 273 shown in FIG. 13, are not shown in this timing diagram. As shown in FIG. 17, time is increasing in a downward direction.

As shown in FIG. 17, a series of host images M1 through MN are produced by an application 1790 operating a host device 1750, respectively, at approximately times T1 through TN. One or more of the host images M1 through MN can be produced in response to one or more operations triggered by the application 1790, in response to interactions of a user with the application 1790 at the host device 1750 via the client device 1700 through a client-host session (e.g., a remote desktop session), and/or so forth. In some embodiments, one or more of the images (or portions thereof) shown in FIG. 17 (e.g., host images M1 through MN, client images, indicators of differences) can be encoded and/or decoded at the host device 250 and/or at the client device 200 shown in FIG. 13.

As shown in FIG. 17, the host image M1 is produced by an application 1790 at approximately time T1. The host image M1 (e.g., a copy of the host image M1) is stored (e.g., cached) as a mirrored host image (which can be encoded) in the host memory 1795, and is sent to the client device 1700 for storage (e.g., caching) in the client memory 1770 as a mirrored host image (which can be encoded). Based on a position of the target display area 63 within the host image M1 (and/or with respect to a host display area) at target coordinates (Z1,O1) a portion F1 of the host image M1 (stored at the client memory 1770) is triggered for display (after being decoded) within the client display 1775 as a client image.

Between times T1 and T2, movement of the target display area 63 is triggered as illustrated by the first offset line shown in FIG. 17. In some embodiments, the target display area 63 can be moved in response to a user-triggered interaction. In this embodiment, the target display area 63 is moved from the target coordinates (Z1,O1) to the target coordinates (Z2, O2). The movement of the target display area 63 (e.g., movement to the new target coordinates (Z2,O2)) can be communicated from the client device 1700 to the host device 1750.

At approximately time T2, the host image M2 is produced by the application 1790. A portion F2 of the host image M2 corresponding with the target display area 63 at target coordinates (Z2, O2) (which is communicated from the client device 1700 to the host device 1750) is compared (as illustrated by the dashed double-sided arrow) with the host image M1 stored in the host memory 1795 to identify differences (e.g., deltas) (if any) between the portion F2 of the host image M2 and the host image M1. In some embodiments, the portion F2 of the host image M2 corresponding with the target display area 63 at target coordinates (Z2, O2) is compared with an area of the host image M1 corresponding with the target display area 63 at target coordinates (Z2, O2) (or another portion of the host image M1). The differences can be encoded (e.g., encoded by the difference encoder 287 shown in FIG. 13) as encoded differences 94 (or indicators thereof), and can be used (e.g., used by a difference decoder) to modify the host image M1 stored in the host memory 1795 to host image M1′. Accordingly, the host image M1′ will be a combination of the host image M1 and the host image M2.

The encoded differences 94 are sent from the host device 1750 to the client device 1700 where the encoded differences 94 can be used (e.g., used by (e.g., decoded by) the difference decoder 273 shown in FIG. 13) to modify the host image M1 stored in the client memory 1770 to host image M1′, which mirrors the host image M1′ stored in the host memory 1795. Based on a position of the target display area 63 within the host image M1′ at target coordinates (Z2,O2) the portion F2 of the host image M1′ (stored at the client memory 1770) is triggered for display within the client display 1775 as a client image.

Between times T2 and T3, movement of the target display area 63 is triggered again as illustrated by the second offset line shown in FIG. 17. In some embodiments, the target display area 63 can be moved in response to a user-triggered interaction. In this embodiment, the target display area 63 is moved from the target coordinates (Z2,O2) to the target coordinates (Z3, O3). The movement of the target display area 63 (e.g., movement to the new target coordinates (Z3,O3)) can be communicated from the client device 1700 to the host device 1750.

At approximately time T3, the host image M3 is produced by the application 1790. A portion F3 of the host image M3 corresponding with the target display area 63 at target coordinates (Z1, O1) is compared (as illustrated by the dashed double-sided arrow) with the host image M1′ stored in the host memory 1795 to identify differences between the portion F3 of the host image M3 and the host image M1′. In some embodiments, the portion F3 of the host image M3 corresponding with the target display area 63 at target coordinates (Z2, O2) is compared with an area of the host image M1′ corresponding with the target display area 63 at target coordinates (Z3, O3) (or another portion of the host image M1′). The differences can be encoded (e.g., encoded by the difference encoder 287 shown in FIG. 13) as encoded differences 95 (or indicators thereof), and can be used to modify the host image M1′ stored in the host memory 1795 to host image M1″. As shown in FIG. 17, the host image M1″ is a combination of the host image M1′ and the host image M3. As shown in FIG. 17, portions of the portion F2 of image M2 are included in the host image M1″.

The encoded differences 95 are sent from the host device 1750 to the client device 1700 where the encoded differences 95 can be used (e.g., used by (e.g., decoded by) the difference decoder 273 shown in FIG. 13) to modify the host image M1′ stored in the client memory 1770 to host image M1″, which mirrors the host image M1″ stored in the host memory 1795. Based on a position of the target display area 63 within the host image M1″ at target coordinates (Z3,O3) the portion F3 of the host image M1″ (stored at the client memory 1770) is triggered for display within the client display 1775 as a client image. In some embodiments, the encoded differences 94 and/or the encoded differences 95 can be based on an area larger than the target display area 63.

Finally, as shown in FIG. 17, the host image MN is produced by the application 1790 at approximately time TN. The host image MN (e.g., a copy of the host image M1) (which can be encoded) is stored as a mirrored host image in the host memory 1795 and replaces a prior mirrored host image (e.g., host image M1″) stored in the host memory 1795. The host image MN is also sent to the client device 1700 for storage in the client memory 1770 as a mirrored host image (which can be encoded) and replaces a prior mirrored host image (e.g., host image M1″) stored in the client memory 1770. Based on a position of a target display area 63 within the host image MN (and/or with respect to a host display area) at target coordinates (Z1,O1) a portion F4 of the host image MN (stored at the client memory 1770) is triggered for display (after being decoded) within the client display 1775 as a client image (the target coordinates (Z1,O1) associated with host image MN are presented by way of example only). In some embodiments, one or more transition images can be defined and triggered for display as a client image in conjunction with the timeline described above (e.g., after time T3 and before time TN, before time T1) based on one or more mirrored images stored at the client memory 1770 and one or more client images triggered for display at the client display 1775.

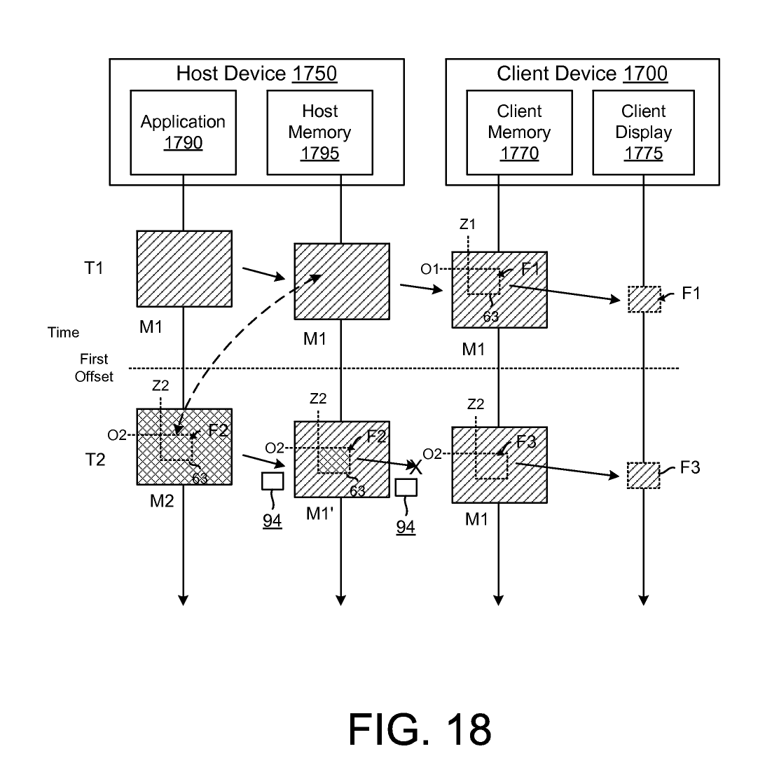

FIG. 18 is a timing diagram that illustrates a modification to the timing diagram shown in FIG. 17. As discussed above in connection with FIG. 17, the host image M1 stored in the host memory 1795 is updated host image M1′ based on an encoded difference 94 from host image M2. In this embodiment, sending of the encoded difference 94 from the host device 1750 is delayed so that the encoded difference 94 is not received at the client device 1700 in time to trigger the display of a client image. In some embodiments, the delay can be caused by a communication error, lack of bandwidth, and/or so forth. Accordingly, the host image M1 is not updated to mirror host image M1′ at the client device 1700 based on the encoded difference 94. Instead, a client image is triggered for display at the client display 1775 based on a portion F3 at target coordinates (Z2,O2) of the host image M1.

Because the client image is triggered for display based on the portion F3 of the host image M1, which is not synchronized with the host image M1′, one or more input values from one or more input device may not be registered (e.g., may be ignored, may be discarded). In other words, interactions with the portion F3 of the host image M1 may be not be registered because the portion F3 of the host image M1 is associated with an outdated host image that does not mirror (e.g., is not synchronized with) a current state of processing of the host device 1750 as reflected in the host image M1′.

In some embodiments, when the encoded difference 94 is finally received at the client device 1700 the host image M1 can be updated to mirror the host image M1′. In some embodiments, the encoded difference 94, because it is not received at the client device 1700, can be requested by the client by 1700. In response to the request, the host device 1750 can be configured to resend the encoded difference 94. In some embodiments, the host image M1 can be updated to mirror the host image M1′, or subsequent host images stored at the host device 1750, based on subsequent encoded differences (or indicators thereof) received at the client device 1700. In some embodiments, the host image M1 can be replaced (before being updated) at the client device 1700 by another host image (e.g., subsequent full-scope host image) received from the host device 1750.

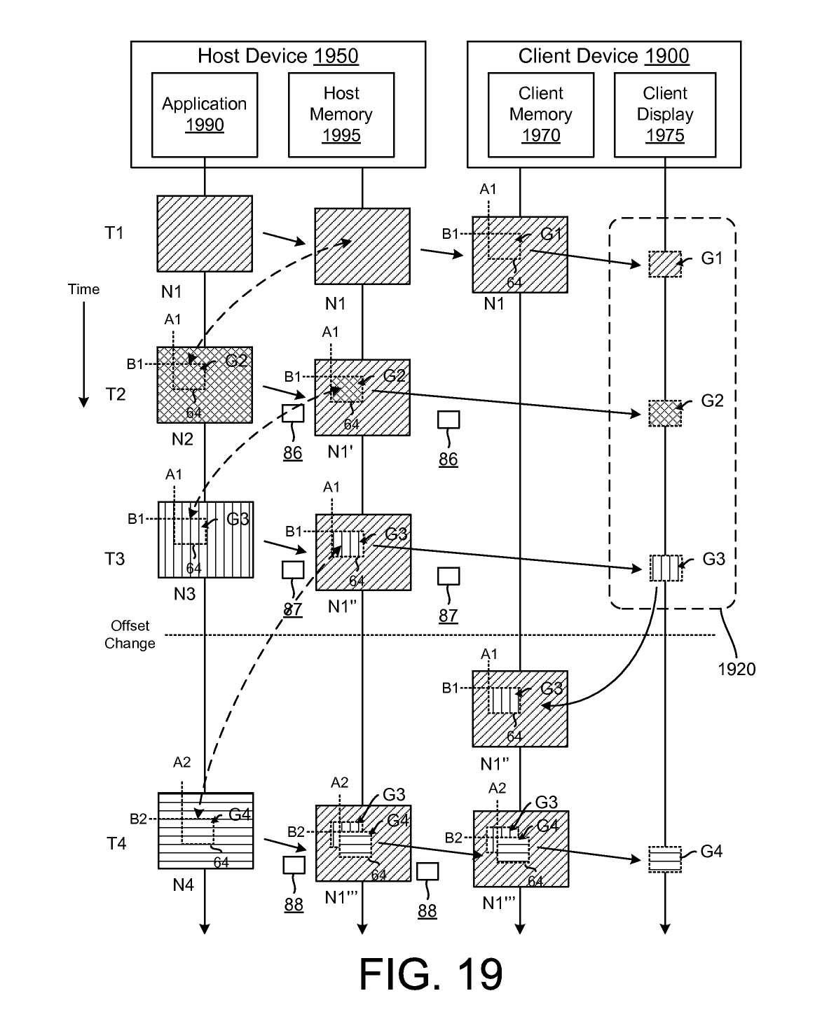

FIG. 19 is a timing diagram that illustrates updating of a mirrored host image based on a sequence of client images 1920 in response to changes in a location of a target display area 64, according to an embodiment. Specifically, the timing diagram illustrates an application 1990 and a host memory 1995 included in a host device 1950, and a client memory 1970 and a client display 1975 included in a client device 1900. At least some processing modules (e.g., image processing modules) included in the host device 1950 and/or in the client device 1900, such as the difference encoder 287 and the difference decoder 273 shown in FIG. 13, are not shown in this timing diagram. As shown in FIG. 19, time is increasing in a downward direction.

As shown in FIG. 19, a series of host images N1 through N4 are produced by an application 1990 operating a host device 1950, respectively, at approximately times T1 through T4. One or more of the host images N1 through N4 can be produced in response to one or more operations triggered by the application 1990, in response to interactions of a user with the application 1990 at the host device 1950 via the client device 1900 through a client-host session (e.g., a remote desktop session), and/or so forth. In some embodiments, one or more of the images (or portions thereof) shown in FIG. 19 (e.g., host images N1 through N4, client images, indicators of differences) can be encoded and/or decoded at the host device 250 and/or at the client device 200 shown in FIG. 13.

As shown in FIG. 19, the host image N1 is produced by an application 1990 at approximately time T1. The host image N1 (e.g., a copy of the host image N1) is stored (e.g., cached) as a mirrored host image (which can be encoded) in the host memory 1995, and is sent to the client device 1900 for storage (e.g., caching) in the client memory 1970 as a mirrored host image (which can be encoded). Based on a position of the target display area 64 within the host image N1 (and/or with respect to a host display area) at target coordinates (A1,B1) a portion G1 of the host image N1 (stored at the client memory 1970) is triggered for display (after being decoded) within the client display 1975 as a client image.

At approximately time T2, the host image N2 is produced by the application 1990. A portion G2 of the host image N2 corresponding with the target display area 64 at target coordinates (A1, B1) (which is communicated from the client device 1900 to the host device 1950) is compared (as illustrated by the dashed double-sided arrow) with the host image N1 stored in the host memory 1995 to identify differences (e.g., deltas) (if any) between the portion G2 of the host image N2 and the host image N1. Specifically, the portion G2 of the host image N2 corresponding with the target display area 64 at target coordinates (A2, B2) is compared with an area of the host image N1 corresponding with the target display area 64 at target coordinates (A2, B2). The differences can be encoded (e.g., encoded by the difference encoder 287 shown in FIG. 13) as encoded differences 86 (or indicators thereof), and can be used (e.g., used by a difference decoder) to modify the host image N1 stored in the host memory 1995 to host image N1′. Accordingly, the host image N1′ stored at the host device 1950 will be a combination of the host image N1 and the host image N2.

The encoded differences 86 are sent from the host device 1950 to the client device 1900. Rather than modifying the host image N1 stored in the client memory 1970 of the client device 1900, the encoded differences 86 can be used to directly update the portion G1 to portion G2 displayed as a client image at the client display 1975. Accordingly, the client image will correspond with the portion G2 included in the host image N1′ stored in the host memory 1995 and the portion G2 included in the host image N2 produced by the application 1990.

At approximately time T3, the host image N3 is produced by the application 1990. A portion G3 of the host image N3 corresponding with the target display area 64 at target coordinates (A1, B1) is compared (as illustrated by the dashed double-sided arrow) with the host image N1′ stored in the host memory 1995 to identify differences between the portion G3 of the host image N3 and the host image N1′. Specifically, the portion G3 of the host image N3 corresponding with the target display area 64 at target coordinates (A1, B1) is compared with an area of the host image N1′ corresponding with the target display area 64 at target coordinates (A1, B1). The differences can be encoded (e.g., encoded by the difference encoder 287 shown in FIG. 13) as encoded differences 87, and can be used to modify the host image N1′ stored in the host memory 1995 to host image N1″.

The encoded differences 87 are sent from the host device 1870 to the client device 1900. Once again, rather than modifying the host image N1 stored in the client memory 1970 of the client device 1900, the encoded differences 86 can be used to directly update the portion G2 to portion G3 displayed as a client image at the client display 1975. Accordingly, the client image will correspond with the portion G3 included in the host image N1″ stored in the host memory 1995 and the portion G3 included in the host image N3 produced by the application 1990.

Because the client images associated with portions G2 and G3 are identified as being valid images produced, respectively, based on the encoded differences 86 and 87, one or more input values from one or more input devices associated with these client images are registered. In other words, one or more input values from one or more input devices are not discarded, and registering of the input value(s) is not disabled (e.g., remains enabled). For example, the client image based on portion G2 (triggered for display at the client display 1975) and associated with the host image N2 includes valid information with which a user may interact.

As shown in FIG. 19, between times T3 and T4, movement of the target display area 64 is triggered as illustrated by the offset line. In some embodiments, the target display area 64 can be moved in response to a user-triggered interaction. In this embodiment, the target display area 64 is moved from the target coordinates (A1,B1) to the target coordinates (A2, B2). The movement of the target display area 64 (e.g., movement to the new target coordinates (A2,B2)) can be communicated from the client device 1900 to the host device 1950.

In this embodiment, in response to movement of the target display area 64, the host image N1 is modified (e.g., updated) to mirror host image N1″ stored in the host memory 1995. In this embodiment, the host image and one can be modified based on the portion G3 displayed within the client display 1975 as a client image. In this embodiment, the portion G3 is associated with the last client image included in the sequence of client images 1920. In this embodiment, the incremental changes (e.g., differences) included in several encoded differences 86, 87 can be used to update the host image N1 to the host image N1″ after several client images have already been displayed based on the several encoded differences 86, 87. By so doing, the host image N1 stored at the client memory 1970 is not updated to host image N1″ until after movement of the target display area 64 is triggered. The host image N1 stored at client memory 1970 is not updated to host image N1″ until several client images that define the sequence of client images 1920 have been displayed.

At approximately time T4, the host image N4 is produced by the application 1990. A portion G4 of the host image N4 corresponding with the target display area 64 at target coordinates (A2, B2) is compared (as illustrated by the dashed double-sided arrow) with the host image N1″ stored in the host memory 1995 to identify differences between the portion G4 of the host image N4 and the host image N1“. Specifically, the portion G4 of the host image N4 corresponding with the target display area 64 at target coordinates (Z2, O2) is compared with an area of the host image N1” corresponding with the target display area 64 at target coordinates (Z2, O2). The differences can be encoded (e.g., encoded by the difference encoder 287 shown in FIG. 13) as encoded differences 88 (or indicators thereof), and can be used to modify the host image N1″ stored in the host memory 1995 to host image N1”’.

The encoded differences 88 are sent from the host device 1950 to the client device 1900 where the encoded differences 88 can be used (e.g., used by (e.g., decoded by) the difference decoder 273 shown in FIG. 13) to modify the host image N1” stored in the client memory 1970 to host image N1′″, which mirrors the host image N1′″ stored in the host memory 1995. Based on a position of the target display area 64 within the host image N1′″ at target coordinates (Z2,O2) the portion G4 of the host image N1′″ (stored at the client memory 1970) is triggered for display within the client display 1975 as a client image. In some embodiments, the encoded differences 86 and/or 88 can be based on an area larger than the target display area 64. In this embodiment, the encoded difference 87 may not be based on an area larger than the target display area 64 because the image N1″ is not synchronized with image N1 stored in the client memory 1970. In some embodiments, one or more transition images can be defined and triggered for display as a client image in conjunction with the timeline described above (e.g., after time T4, before time T1) based on one or more mirrored images stored at the client memory 1970 and one or more client images triggered for display at the client display 1975.

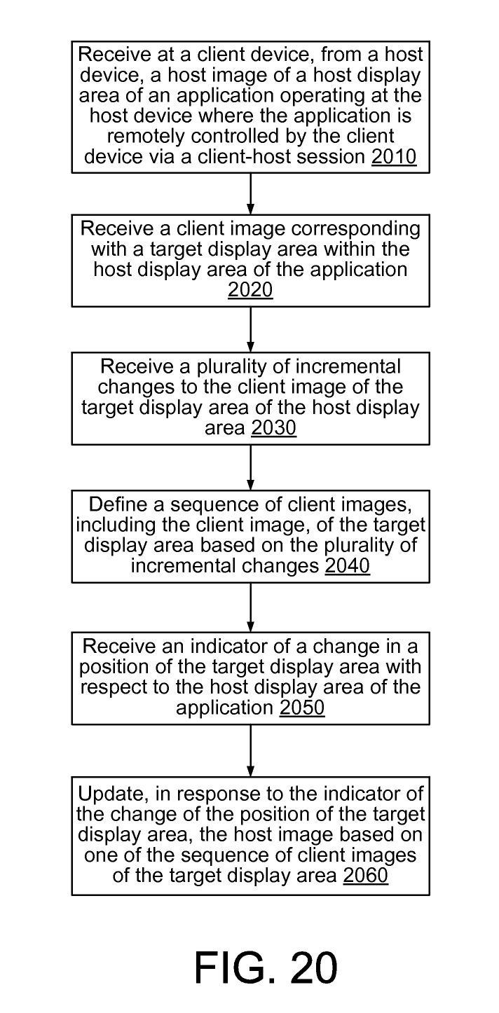

FIG. 20 is a flowchart that illustrates a method for processing mirrored images associated with a sequence of client images, according to embodiment. At least some portions of the flowchart can be performed by a client device and/or a host device such as those shown in FIG. 2 and FIG. 13.

A host image of a host display area of an application operating at the host device is received at a client device from a host device where the application being remotely controlled by the client device via a client-host session (block 2010). In some embodiments, the host image of the host display area of the application operating host device can be received at the host image processor 278 of the client device 200 shown in FIG. 13. In some embodiments, the host image can be referred to as a mirrored host image.

A client image corresponding with a target display area within the host display area of the application is received (block 2020). In some embodiments, the client image can be received at the client image processor 277 of the client device 200 shown in FIG. 13. In some embodiments, the client image can have a boundary that corresponds with a boundary of the target display area. In some embodiments, the client image can be based on a position of the target display area within the host display area.

A plurality of incremental changes to the client image of the target display area of the host display is received (block 2030). In some embodiments, the plurality of incremental changes to the client image can be received by, for example, the difference decoder 273 of the client device 200 shown in FIG. 13. In some embodiments, the incremental changes to the client image can be used to update a host image stored at the host device.

A sequence of client images, including the client image, of the target display area is defined based on the plurality of incremental changes (block 2040). In some embodiments, the sequence of client images can be serially triggered for display at the client device. In some embodiments, the sequence of client images can be triggered for display without updating the host image.

An indicator of a change in a position of the target display area with respect to the host display area of the application is received (block 2050). In some embodiments, the indicator of the change in the position of the target display area can be triggered via the client target movement module 235 of the client device 200 shown in FIG. 13.

The host image is updated in response to the indicator of the change of the position of the target display area based on one of the sequence of client images of the target display area (block 2060). In some embodiments, the host image can be updated by the difference decoder 273 of the client device 200 shown in FIG. 13. In some embodiments, the host image, when updated, can mirror (e.g., can be synchronized with, can be a duplicate of) a host image stored at the host device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium), for processing by, or to control the operation of, data processing apparatus, e.g., a programmable processor, a computer, or multiple computers. Thus, a computer-readable storage medium can be configured to store instructions that when executed cause a processor (e.g., a processor at a host device, a processor at a client device) to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer-readable storage medium storing instructions that when executed cause a processor to perform a process, the process comprising:
sending from a client device to a host device an indicator of a size of a target display area of the client device and an offset boundary defining a boundary limiting movement of the target display area with respect to a host display area of an application operating at the host device, the application being remotely controlled via the client device;
defining an indicator of a position of the target display area of the client device with respect to the host display area; and
receiving from the host device an image of a target display area of the host display area of the application, the host display area having a resolution different from a resolution of the target display area of the client device.

2. The computer-readable storage medium of claim 1, wherein the offset boundary is included entirely within the host display area,
the process further comprising:
receiving at the client device a size of the host display area of the application; and
defining at least a portion of the offset boundary based on the size of the host display area.

3. The computer-readable storage medium of claim 1, wherein the indicator of the position is with respect to an origin of the host display area.

4. The computer-readable storage medium of claim 1, wherein the indicator of the position is an indicator of a change in position of the target display area with respect to the host display area.

5. The computer-readable storage medium of claim 1, wherein the indicator of the position includes an indicator of an offset of the target display area from an origin location of the host display area,
the processing further comprising:
calculating an indicator of a position of a cursor within the host display area based on the indicator of the offset and based on the origin location of the host display area.

6. The computer-readable storage medium of claim 1, wherein the offset boundary includes a maximum horizontal width and a maximum vertical height.

7. The computer-readable storage medium of claim 1, wherein the offset boundary includes at least one of a maximum horizontal width greater than a width of the resolution of the host display area minus a width of the target display area, or a maximum vertical height greater than a height of the resolution of the host display area minus a height of the target display area.

8. The computer-readable storage medium of claim 1, wherein an aspect ratio of the target display is different than an aspect ratio of the host display area.

9. The computer-readable storage medium of claim 1, wherein the host display area includes a host image of at least one user interface of the application.

10. A method, comprising:
establishing at least a portion of a remote desktop session between a client device and a host device,
receiving an offset boundary defining a boundary for movement of a target display area with respect to a host display area of an application operating at the host device;
receiving from the client device an indicator of a position of a target display area within a host display area of an application operating at the host device;
defining a client image based on a portion of a host image corresponding with the target display area at the position within the host display area, the image of the target display area having an area smaller than an area of the host image of the host display area; and
sending the client image to the client device.

11. The method of claim 10, wherein the client image has a size equal to a size of the target display area.

12. The method of claim 10, wherein the client image has an area smaller than an area of the target display area.

13. The method of claim 10, wherein the client image includes a portion of the host image with an aspect ratio different than an aspect ratio of the target display area based on a limitation defined within the offset boundary.

14. The method of claim 10, wherein the indicator of the position is with respect to a default origin of the host display area of the application.

15. The method of claim 10, wherein the image of the target display area is of a first target display area, the client image is a first client image,
the method further comprising:
receiving from the client device an indicator of a change in the position of the target display area within the host display area of the application; and
sending to the client device a second client image of the host display area of the application based on the indicator of the changed position.

16. An apparatus, comprising:
a host connection module of a host device configured to exchange a plurality of an initialization parameter values with a client device during establishment of a remote desktop session between the host device and the client device,
at least a portion of the plurality of initialization parameter values identifying an aspect ratio of a target display area with respect to a plurality of host images produced within a host display area by an application operating at the host device;
a host target movement module configured to receive from the client device an indicator of a position of the target display area with respect to the host display area; and
a client image generator configured to define a client image based on at least one host image from the plurality of host images produced within the host display area and based on the indicator of the position of the target display area with respect to the host display area.

17. The apparatus of claim 16, wherein the plurality of initialization parameter values identify an origin of the host display area of the application operating at the host device.

18. The apparatus of claim 16, wherein the target display area has a first portion disposed within the host display area and a second portion disposed outside of the host display area.

19. The apparatus of claim 16, further comprising:
a host input device module configured to calculate a position of a cursor within the host display area based on an indicator of a position, relative to an area of the client image, of an input value produced by an input device of the client device.

20. The apparatus of claim 16, wherein the host connection module is configured to receive an offset boundary defining a boundary of movement of target display area with respect to the host display area, the client image generator is configured to define at least a portion of the client image based on a background image outside of the host display area and within the boundary of movement defined by the offset boundary.
